(19) United States
(12) Patent Application Publication
(10) Pub. No.: US 2026/0210133 A1
(43) Pub. Date: Jul. 23, 2026

(54) MANUAL CONCRETE FINISHING TOOLS AND COMPONENTS FOR USE THEREWITH

(71) Applicant: Baron Innovative Technology LP, Oxnard, CA (US)

(72) Inventor: Anthony Baratta, Oak Park, CA (US)

(73) Assignee: Baron Innovative Technology LP, Oxnard, CA (US)

(21) Appl. No.: 19/144,472

(22) PCT Filed: Jan. 12, 2024
(86) PCT No.: PCT/US24/11517

§ 371 Date: Jun. 28, 2025

Related U.S. Application Data
(60) Provisional application No. 63/439,056, filed on Jan. 13, 2023.

(51) Int. Cl. E04F 21/16; B25G 3/04; E04F 21/24

(52) U.S. Cl. CPC E04F 21/163; B25G 3/04; E04F 21/244

(57) ABSTRACT

A manual concrete tool includes a tool body, a handle or pole attachment on one side of the tool body and a concrete finishing surface on a second side of the tool body, and a finishing element configured to be positioned in the concrete finishing surface. One or both of the handle or pole attachment and the finishing element are removable. In one configuration, the finishing element is a blade for grooving concrete, and a kit can include the tool and/or a plurality of interchangeable blades.

### BACKGROUND

### Field

These inventions relate to concrete finishing tools, which include both shaping and finishing tool assemblies, including such tools as pole-mounted and hand tools and their components, including for example grooving, edging and float finishing tools and components.

### SUMMARY

Manual concrete finishing tools such as handheld and pole mounted concrete finishing tools include trowels, groovers, blades, edgers, margin edgers, slab to step tools and walking groovers. All of these are example concrete finishing tools that can incorporate one or more of the components or combinations described herein. As used herein, “finishing” shall refer to tools and components for both finishing and shaping concrete, and includes not only items such as tools used for final finishing of a concrete surface, but also to items that are used for shaping and for working concrete before the concrete is cured, and “finishing” is not used as a temporal term in the context of when concrete is worked relative to its cured state, and is not used as a term indicating sequence of working tools such as the last tool to be applied to the concrete. The tools referenced herein such as trowels, groovers, blades, edgers, margin edgers, slab to step tools and walking groovers are all included in the phrase finishing tools as used herein. As an example of such tools that can benefit from the improvements described herein, common handheld groovers will be presented for illustration. Handheld groovers can include a finishing surface or a finishing element, such as a trowel surface, with a forming/shaping/finishing element, for example a contoured surface, a blade, fin or other projection from the finishing surface for creating the desired effect in the concrete, such as a groove or edge, or such as a float with a finishing surface, all of which are hereinafter referred to generically as a finishing element. The forming/shaping/finishing elements on the other tools herein such as trowels, blades, edgers, margin edgers, slab to step tools and walking groovers are also hereinafter referred to generically as a finishing element. The finishing element is incorporated into a tool body with a handle or pole for controlling the tool. However, it is understood that mention of a more specific shaping/finishing tool is as an example and not by way of limitation, and other shaping/finishing tools can be substituted. In any of the concrete finishing tool assemblies described herein for which a handle or a pole are removable or interchangeable on the tool, a description of the tool with a handle or a description of the tool with a pole is to be understood as including a description of the tool with the other of a handle or a pole. However, in a number of examples of tools herein, a handle is described for convenience or simplicity, but it is understood that the tool can likewise have a pole instead.

In one configuration, either or both of the handle (or pole as noted herein) and the finishing element are removable to allow adjusting of the handle or exchanging handles, exchanging finishing elements for producing a different contoured surface, or to replace a worn element. In one configuration, the finishing surface of the tool opposite the handle is substantially planar and includes a groove into or recessed in the planar finishing surface for receiving a base element of the finishing element. In one example, the base element includes wall portions that are substantially flush with the substantially planar finishing surface when the finishing element is in place. In a further example, the groove in the finishing surface is positioned intermediate two portions of the finishing surface, and the base element includes respective walls that are substantially flush with respective adjacent portions of the finishing surface. In a further example, the groove in the finishing surface is positioned at a lateral side portion of the finishing surface, and the base element includes at least one wall that is substantially flush with a respective adjacent portion of the finishing surface, for example in an edging tool.

In any of the examples herein of concrete finishing tools, a tool body may include a securement or engagement structure, for example a latch, release or magnet or hook, within or interior to a body profile, wherein the securement is for securing and/or positioning a finishing element in the tool body. In one configuration, the body profile has a first side defined by a plane of a finishing surface of the tool body. In another configuration, the securement is entirely contained within an interior of the tool body or interior to the body profile, for example within a perimeter of a groove, or within an interior of the body recessed below the finishing surface of the tool. In such a configuration, the securement can be away from the finishing surface, and exposure to the elements such as water and concrete and debris is reduced or eliminated. The securement can be invisible when the finishing element is in place. Also in such a configuration, actuation, release or engagement of the securement can be accomplished without touching one or more components of the securement, but instead by manipulating components on the outside portions of, for example, a handle and exposed portions of the finishing element.

In any of the examples herein of concrete finishing tools, a tool body may include a securement, for example a latch, release or magnet or hook, in a groove for securing and/or positioning a finishing element in the groove. In one configuration, the securement is in the groove and entirely contained within an interior of the tool body, for example within a perimeter of the groove, or within an interior of the body recessed below the finishing surface of the tool. In such a configuration, the securement can be away from the finishing surface, and exposure to the elements such as water and concrete and debris is reduced or eliminated. Also in such a configuration, actuation, release or engagement of the securement can be accomplished without touching one or more components of the securement, but instead by manipulating components on the outside portions of, for example, a handle and exposed portions of the finishing element.

In any of the examples herein of concrete finishing tools, a tool body may include a securement, for example a latch, release or magnet, adjacent a groove for securing and/or positioning the finishing element in the groove. In one example, a latch includes a compressible element, for example a bias, for biasing the element in a first direction, which in at least one configuration is parallel to a direction of movement when the finishing tool is in use. In some configurations, the tool may have a forward direction or a predominantly forward direction, and the first direction is opposite the forward direction. In one example, the bias is a spring and may be a compression spring.

In any of the examples herein of concrete finishing tools, a tool body may include a securement within a perimeter of a groove including one or more structures that biases the finishing element in the direction of a base of the groove. As used herein, “securement” means a securement configuration that may include a single element or multiple elements, either in an assembly or configured in such a way that they contribute to securing elements together, whether a tool body and finishing element or components thereof. In one example, one or more of the structures may include a ramp wall, a cam wall, an angled surface, a resilient structure, which may be a material, and/or a spring tending to move the finishing element toward the tool body, for example, the base of the groove more than not. In one configuration, a spring, for example a compression spring compressible approximately in a direction parallel to the base of the groove, biases the finishing element so that one or more surfaces on the finishing element tend to follow a wall or surface moving the finishing element closer to the base of the groove. Similar results can be achieved with a bias oriented other than in a direction parallel to the base of the groove. In another configuration, magnets or other attractive or combining forces bias the finishing element closer the tool body, for example to the base of the groove.

In any of the examples herein of concrete finishing tools, a tool body may include an at least partially planar finishing surface and a groove or cavity extending below the finishing surface or in a direction into the tool body away from a direction in which the finishing surface faces (away from the worksurface). The tool body can include a pivot surface for receiving or engaging a portion of a removable finishing element so that the portion of the removable finishing element can pivot on the surface or relative to the surface as the removable finishing element is being installed onto or removed from the tool body. In one example, the pivot surface is configured so that the portion of the removable finishing element that pivots will pivot on an axis below the plane of the finishing surface, and in another example the pivot surface is configured so that the portion of the removable finishing element that pivots will pivot on an axis that extends substantially parallel to the planar surface. In a further example, the finishing tool has a direction of travel and the axis extends transversely of the direction of travel. In another example, the axis does not intersect the planar portion of the finishing surface.

In any of the examples herein of concrete finishing tools, the tool body may include a releasable retention element, such as a latch and guide structures for the latch, one or more magnets or other securements. In one configuration, the retention element is limited in rotation and lateral movement, and the retention element moves substantially axially, for example along a guide for positioning the retention element in the tool body. In one example, the retention element moves axially against, for example within, a coil spring, for example a helical compression spring. In another example, the retention element includes a seat for receiving a portion of the finishing element, for example a non-flat contact surface for receiving a contact element on a finishing element. In one configuration, the contact surface is substantially partially circular, for example having an arc that is less than a half circle. In one example, the contact surface is formed in a wing structure on the retention element, and the wing structure includes grooves or slots for riding on rails in the tool body for limiting rotational and lateral movement of the retention element. In another example, the retention element includes one or more magnets for attracting another magnetic element closer to the tool body. In one configuration, tool body has a magnet, for example in a groove, and a releasable finishing element having a magnet or magnet responsive element is drawn toward the magnet on the tool body. Other securement elements can be used to releasably secure a removable finishing element with, onto or into a tool body.

In any of the examples herein of concrete finishing tools, the tool body may include at least one angled wall for receiving a portion of the removable finishing element, for example a projection on the finishing element. In one example, the angled wall is contacted by a similarly angled wall of the finishing element for limiting the finishing element from moving away from the finishing surface of the tool body, for example in a direction at least partly perpendicular to the finishing surface. In another example, the angled wall is contacted by a portion of a base of the finishing element as the finishing element is angled or pivoted into position, for example in a groove in the finishing surface of the tool body. A sidewall of a groove in the tool for receiving a removable finishing element may also be angled for limiting movement of the removable finishing element in the same plane as a plane of the finishing surface of the tool. The sidewall of the groove may also be other than linear in the direction of travel of the tool, for example to limit movement of the removable finishing element in the direction or opposite to the direction of movement of the tool. The angled wall contacted by a portion of the base makes easier the assembly and retention of a finishing element onto the tool body.

In any of the examples herein of concrete finishing tools, a removable finishing element can be configured to be removably retained in the tool body. A finishing element, for example but not by way of limitation, can have first and second securement elements for engaging respective receiving and preferably complementary structures in the tool body to securely hold the element relative to the tool body, for example during normal use of the tool. In one example, the finishing element can include at least partly oppositely-facing surfaces for engaging complementary surfaces in the tool body to help secure the finishing element in place on the tool body. For example, an angled surface for engaging a complementary angled surface in the tool body can help secure the finishing element in place on the tool body. In another example, the finishing element can include a seating element for engaging a seat in the tool body to help secure the finishing element in place on the tool body. In one configuration, the seating element is an angled projection for bearing against the seat in the tool body. In one example, the seating element includes an arcuate or non-flat surface for engaging an arcuate or non-flat surface in the tool body, for example an arcuate seat on a retention element. In one example, the arcuate seat is on an end of the retention element and the seating element includes a rounded convex surface complementary to the surface, for example the arcuate seat, of the retention element. In a configuration of the tool body where the retention element is biased, for example with a compression spring, the seating element can engage the seat on the retention element, compress the spring, and allow another securement element on the finishing element to engage the tool body, after which the compression spring biases the other securement element in the tool body.

In any of the examples herein of concrete finishing tools having a removable finishing element, the tool can include a compressible element between at least a portion of the tool body and at least a portion of the removable finishing element. In one example, the compressible element is a spring between a body portion of the removable finishing element and an adjacent portion of the tool body. The adjacent portion of the tool body may include a cavity for positioning the spring between the tool body and the removable finishing element. In another example, the compressible element may be a foam or other resilient material between part of the tool body and part of the removable finishing element that can be compressed when the removable finishing element is being installed on the tool body. The foam or other resilient material may be a non-metal material. The foam or other resilient material may have a planar geometry and may be compressible into the plane of the material. The foam or other resilient material may form a gasket for sealing a portion of an interface between a tool body and a removable finishing element.

For use in any of the examples herein of concrete finishing tools having removable finishing elements, removable finishing elements may be configured to fit reliably with the finishing tool body. A reliable fit for the removable finishing element is relevant to providing the desired finish to the workpiece and to ensure reliable securement of the removable finishing element to the tool body. A reliable fit is also useful to ensuring repeatable performance between one and another removable finishing elements in a group of removable finishing elements, any one of which is usable on the tool body. Each of the plurality of removable finishing elements in a group of finishing elements usable on a given tool body is preferably equally interchangeable on the tool and equally reliably secured in the tool from one finishing element to the next. In one example, the removable finishing element includes a perimeter surface defining a plane and a first clip or protrusion extending out of the plane and at least partly away from the rest of the removable finishing element for engaging an adjacent portion of the tool body, wherein a transverse portion of the clips or protrusion defines a pivot axis parallel to and spaced apart from a plane. In one configuration, the pivot axis is spaced a first distance from the plane an amount that is substantially equal for all of the removable finishing elements to be used with a given tool configuration. In another example, a maximum spacing of the clip or protrusion from the plane is substantially the same for all of the removable finishing elements to be used with a given tool configuration, for example as a kit or assembly of removable finishing elements. In a further example, a clip or protrusion includes a distal-most surface and the perimeter includes a proximal-most surface, and the distal-proximal distance is substantially the same for all of the removable finishing elements to be used with a given tool configuration. In a further example, a removable finishing element includes first and second clips or protrusions extending from the plane, for example extending upward from the plane and toward each other, and having a first minimum spacing between the first and second clips or protrusions. The first minimum spacing is substantially the same for all of the removable finishing elements to be used with a given tool configuration. Having substantially the same configurations between interchangeable removable finishing elements allows for reliable interchange of removable finishing elements on a given tool body.

In any of the examples of a tool described herein having a tool body, wherein the tool body has an at least partially planar finishing surface and a control mounting structure (for example for a control structure, including without limitation a handle or pole), the tool body including the at least partially planar finishing surface and control mounting structure has a substantially uniform thickness over at least 50% of the tool body and the remainder of the tool body includes reinforcement structures, for example ribs, projections, lines, walls or other reinforcements. In one example, the tool body can include a dovetail interface structure for releasable and/or movable or adjustable securement of a handle or pole attachment, and walls of the dovetail interface structure can have approximately the same thickness as walls of the remainder of the tool body except for the reinforcement structures.

In any of the examples of a tool described herein, a tool can include a finishing surface on a first side of a planar tool body, and a handle or pole attachment element opposite the finishing surface, wherein the attachment element is raised from the planar tool body in a direction opposite the direction in which the finishing surface faces. The attachment element may include a recessed or hollow portion or cavity within the attachment element for receiving or incorporating securement elements (including any of those described herein) and/or positioning components for securing a removable finishing element. In one configuration, the attachment element can have a dovetail configuration for removably receiving a handle or pole attachment element.

In any of the examples herein of a tool, a tool can include a removable handle or pole mount having threads and a nut threaded onto the threads wherein the nut and the tool body are configured to place an engagement between the handle and the tool body in tension. In one example, threading of the nut toward the tool body places the engagement in tension. In one configuration, the threads on the handle are formed on a cylinder positioned between a gripping element on the handle and dovetail groove walls configured to engage a dovetail on the tool body. In one example, the tool body includes a dovetail extending longitudinally, and the handle is configured to be installed and removed by sliding the handle longitudinally along the dovetail. The handle can be secured by threading the nut on the handle downward against an upwardly-facing surface fixed relative to the dovetail, for example on top of the dovetail.

In any of the examples herein of a tool having a removable handle or pole mount, a handle or pole mount can be secured in part by a load-bearing element having a higher coefficient of friction than a portion of the handle or pole mount. In one example, where the removable handle or pole mount includes a nut having threads, a bearing surface on the nut bears against an adjacent surface on the tool to secure the removable handle or pole mount and the tool together. In one configuration, the bearing surface on a bottom portion of the nut includes a higher friction material than the material of the rest of the nut, and for example may include a polymer material having a higher coefficient of friction than one or all of the other parts of the nut. In one example, the higher friction material is formed as a ring set into an annular groove or attached to the bearing surface of the nut for contacting an adjacent surface on the tool.

For any of the tools described herein, and interface assembly can be used in between a control structure and a tool body providing a degree of freedom by which the control structure can be releasably pivoted relative to the tool body. Pivoting can occur over increments of 180° to a small as 5°, depending on the construction of the assembly. In one configuration, and interface assembly for a manual tool can include first and second housing bodies join together in such a way that they can be releasably locked relative to each other at selected pivot angles. The first housing body can receive a control mechanism such as a handle or pole mount, either removably or fixed, and the second housing body can receive a tool body such as any of the tool bodies described herein, either removably or fixed. In one configuration, either or both of the first and second housing bodies have dovetail configurations for engaging the respective components, such as a control mechanism for a tool body. One of the housing bodies supports a non-circular indexing element that can be releasably fixed in the housing body against pivoting while permitting the indexing element to be repositioned in order to change a pivot angle between the first and second housing bodies. For example, the indexing element may be fixed to the first housing body and supported in the second housing body in such a way that indexing element can be moved to a different position in the second housing body, thereby effecting a different pivot position between the first and second housing bodies. In one configuration, the indexing element includes a plurality of tabs about the indexing element, for example for engaging respective cavities in the second housing body. In another configuration, the indexing element includes a plurality of teeth distributed about the indexing element. In one configuration, the indexing element includes a plurality of tabs around a perimeter of the indexing element and a plurality of teeth around an interior wall, for example where the indexing element has an annular configuration with the tabs on the outside and teeth on the inside. The housings of the interface assembly can be pivotally changed relative to each other without disengaging the indexing element from the second housing, example by disengaging a lock element such as a locking arm having teeth from the teeth on the indexing element and pivoting the first housing and a lock element relative to the second housing and the indexing element, and thereafter re-engaging the teeth of the locking element with the teeth on the indexing element. Pivoting of the first and second housings may be facilitated with bearings.

In any of the examples herein of a tool having a removable handle or pole mount, either of the tool, handle or pole mount can include a releasable locking interface for allowing selective pivoting movement of the tool, handle or pole mount in a plane parallel to a plane, for example a plane of the finishing surface of the tool, or a plane of the handle or pole mount. The interface can include a turret releasably lockable in a number of angular positions, which may also allow pivoting over 360°, and positioning in 5° increments. In other configurations, the positioning can be in 10, 15, 20, 25, 30 or 45° increments or larger. However, with the examples of the tools described herein, positioning in 5° increments is helpful.

In any of the examples herein of the tool, a handle on the tool can have one or more angled surfaces for allowing the angled surface to rest against a flat surface, for example so that the tool assembly can rest in a stable configuration on the angled surface of the handle and an adjacent end of the tool body. This can help reduce damage to the finishing element and/or the finishing surface on the tool body.

In use, a finishing element can be assembled onto a tool body by engaging a seating surface against a movable seat in the tool body, and moving the movable seat in a direction of an opposite end of the finishing element. An engagement element, such as an angled surface, barb, hook, or latch structure can be positioned into an opening in the tool body, to engage a corresponding cavity, surface or other structure for engaging the angled surface, barb, hook or latch structure. With such engagement, the finishing element can be fully seated against the adjacent surface of the tool body, and the movable seat returned in the direction of its original position, which can help to reliably engage the angled surface, barb, hook or latch structure with a corresponding structure in the respective cavity. The seating element can stay seated in the movable seat. In one configuration, a bias encourages the seat and seating element to remain engaged during normal use of the tool. The tool can then be used as desired. In one configuration, normal motion of the tool can be in a first direction, and a bias can bias the finishing element in the opposite direction.

To remove the finishing element, for example to exchange or replace the finishing element, the finishing element can be moved against the seat for moving the retention element sufficiently to allow the angled surface, barb, hook or latch structure to be removed from the tool body, for example to withdraw it from the cavity or other structure with which it was engaged. Once it is disengaged, the opposite end of the finishing element can be unseated from its seat in the retention element, and the finishing element removed. In one configuration, multiple finishing elements can have identical mounting structures for engaging the tool body, and a tool body and/or multiple finishing elements can be assembled in a kit for convenience of the user.

These and other examples are set forth more fully below in conjunction with drawings, a brief description of which follows.

### BRIEF DESCRIPTION OF THE DRAWINGS

FIG. 1 is an upper side isometric view of a concrete finishing tool and a removable finishing or shaping element, and an exchangeable finishing or shaping element, for example to exchange with the finishing element that is installed on the tool.

FIG. 2 is a lower side isometric view of the components in FIG. 1.

FIG. 3 is a lower side isometric view of the tool of FIG. 1 with the finishing element removed.

FIG. 4 is an upper side isometric view of a finishing element for use with the tool of FIG. 1, showing structures for use in engaging a corresponding portion of the tool body.

FIG. 5 is a longitudinal cross-section of one of the finishing elements of FIG. 1.

FIG. 6 is a longitudinal cross-section of the tool body and finishing element of FIG. 1 without a handle assembly.

FIG. 7 is a detail view of a portion of the assembly in FIG. 6.

FIG. 8 is an upper isometric view of a releasable retention element having a seat for receiving a seating element on a removable finishing element.

FIG. 9 is a rear end elevation view of the tool of FIG. 1.

FIG. 9A is a side elevation view of a tool body and a schematic depiction of a body envelope representing a three-dimensional space within which the tool body is contained as defined by maximum length, width, and height dimensions of the tool body.

FIG. 9B is a side elevation and longitudinal center cross-section of the tool body illustrated in FIG. 9A and a schematic depiction of a body profile representing a two-dimensional space within which the tool body is contained as defined by a center profile of the tool body.

FIG. 10 is a detail of a portion of the handle showing a threaded cylindrical handle portion and dovetail walls forming a dovetail groove.

FIG. 11 is a plan view of a handle knob showing a gripping surface configuration and a friction element.

FIG. 12 is a sagittal cross-section and detail view of a portion of a tool such as that shown in FIG. 1 showing multiple resilient structures or elements.

FIG. 13 is a transverse vertical cross-section of a tool such as that shown in FIG. 1.

FIG. 14 is a detail of a portion of the section shown in FIG. 13.

FIG. 15 is a lower isometric view of another example of a tool with a removable finishing element releasably secured through a magnet and wherein positioning of the finishing element is assisted by barrier structures such as curved sidewalls and lands and grooves.

FIG. 16 is an upper isometric view of the tool of FIG. 15.

FIG. 17 is a partial side section of the assembly of FIG. 15 showing a pivot cam and base hook engagement and engagement lands and grooves.

FIG. 18 is an upper left isometric view of an alternative control structure in the form of a cantilever handle for use with any of the tools herein.

FIG. 19 is a side elevation view of the handle of FIG. 18.

FIG. 20 is an upper left isometric view of an alternative control structure in the form of a pole mount for use with any of the tools herein and including a releasable indexing interface configuration.

FIG. 21 is a top plan view of a portion of the assembly of FIG. 20.

FIG. 22 is a bottom plan view of a portion of the assembly of FIGS. 20-21.

FIG. 23 is vertical cross section through a portion of a pivot indexing interface assembly.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of tools and of methods of making and using the tools are described. Exemplary handheld and pole mounted concrete finishing tools include trowels, groovers, blades, edgers, margin edgers, slab to step tools and walking groovers. Depending on what feature or features are incorporated in a given structure or a given method, benefits can be achieved in the structure or the method. For example, tools using interchangeable finishing elements simplify the user's toolkit and lower the overall cost for the tools. Additionally, tools with a reliable and easy to use securement configuration saves time and simplifies use, and no fastening tools are required. Additionally, tools, for example hand groovers, that are made individually for different sizes produce a different feel for each one during use because of variations arising during manufacture. The present tool configurations provide tool constructions having a reduced variability between sizes when the different sizes can be used on a single body. Furthermore, a handle attachment system using a relatively large engagement surface area improves the reliability and structural integrity of the handle attachment assembly.

In some configurations of tools, improvements can be achieved also in interchangeability, and in some configurations, the user has the choice of using only a single tool body construction if desired to provide a larger number of configurations of finishing tools. For example, a tool with a recessed receiving and supporting area for receiving and supporting a variety of finishing configurations all having the same base for engaging the tool body means that different shaped tools each having the same base and attachment configuration can be used on a single tool body.

These and other benefits will become more apparent with consideration of the description of the examples herein. However, it should be understood that not all of the benefits or features discussed with respect to a particular example must be incorporated into a tool, component or method in order to achieve one or more benefits contemplated by these examples. Additionally, it should be understood that features of the examples can be incorporated into a tool, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of tool configurations and of methods of making and using the tools are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

Hand groovers are used as examples of a tool that can incorporate one or more of the features and derive some of the benefits described herein.

There are a large variety of hand tools used for finishing concrete, and many of those tool configurations can be used with a universal hand element such as a hand tool body to help make use of the tools more efficient. Examples of such tools include groovers, and edgers for forming a corner, bullnose, and other shapes. However, only tools for grooving will be described. Tools other than hand groovers can benefit from one or more of the present inventions.

As used herein, “substantially” shall mean the designated parameter or configuration, plus or minus 10%. However, it should be understood that terminology used for orientation or relative position, such as front, rear, side, left and right, upper and lower, and the like, may be used in the Detailed Description for ease of understanding and reference, and may not be used as exclusive terms for the structures being described and illustrated.

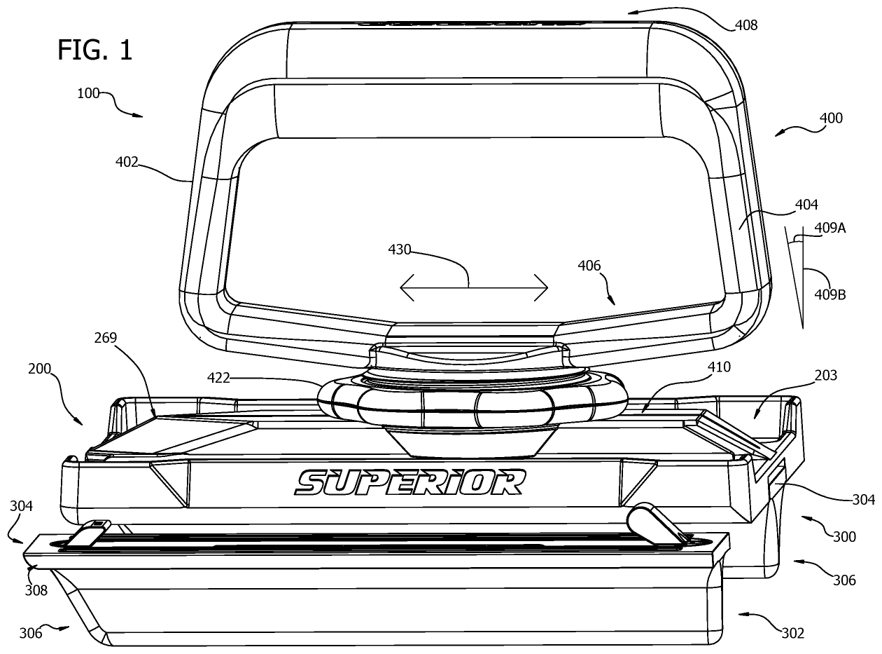

Handheld concrete finishing tools such as a hand held groover 100 (FIGS. 1-4) can have a number of configurations, for example a number of handle configurations, and a number of tool body configurations. In the illustrated example, the groover 100 includes a tool body 200, a finishing element 300, which as illustrated is a grooving blade, and a handle assembly 400, each of which can take a number of configurations. In the present example, the tool body includes a substantially planar finishing surface 202 facing the concrete surface during use, and a control mounting structure 203 on an upper surface opposite the finishing surface for receiving and supporting the handle assembly 400. In the present examples, the finishing element has two portions, the first portion corresponding to the shape to be formed in the concrete and the second portion corresponding to the structure and means for engaging the lower side of the tool body. The shape can take any number of configurations as desired for forming the concrete, but the structure and means for engaging the tool body will be specific for the engagement configuration for the tool body. Similarly, the handle assembly 400 has two portions, the first portion corresponding to the structure used by the user for manipulating the tool and a second portion corresponding to the structure for securing the handle and the control mounting structure on the tool body relative to each other. Therefore, the first portions of the finishing element and the handle can be varied as desired, and the second portions of the finishing element and the handle will conform to the extent necessary for being used with the desired tool body.

In the illustrated configuration of the tool assembly, both of the finishing element and the handle are removable, and different finishing elements and different handles may be used on the tool body. Alternatively, one or the other of the finishing element and handle can be fixed to the tool body to be permanent.

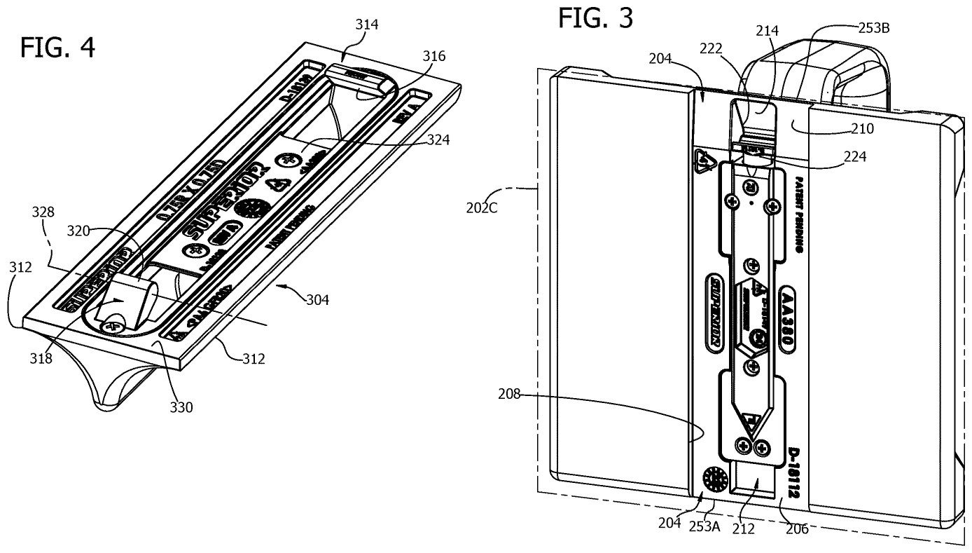

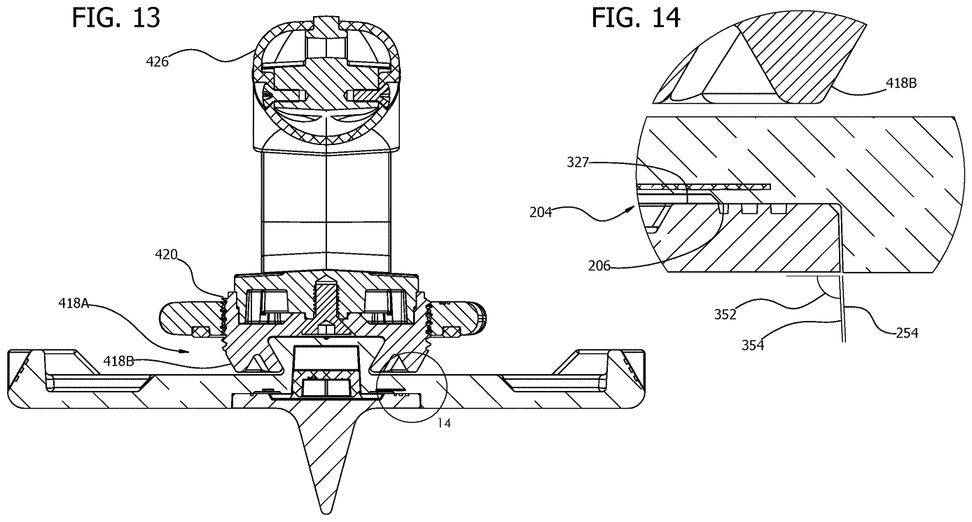

The tool body as illustrated is substantially rectangular in plan view, though other geometries can be used, and the finishing surface 202 is substantially planar, facing in the direction of the surface to be finished, and defines a finishing surface plane 202C (FIG. 3) when the finishing surface is uniformly flat, as in the present examples. A channel or groove 204 is formed or is recessed in and extends longitudinally of the finishing surface. As illustrated, the channel or groove 204 is substantially centered widthwise of the finishing surface, or intermediate two portions of the finishing surface, 202A and 202B, though it can be positioned otherwise relative to the perimeter of the finishing surface or to the handle axis. The channel or groove 204 as illustrated extends substantially the entire length of the finishing surface, but need not do so if desired. In the present example, the channel or groove 204 is configured as substantially rectilinear with a discreet depth, less than the overall height of the tool body (in a Z direction, from the finishing surface to a top of control mounting structure so that the two portions of the finishing surface are not separable), but other geometries are possible while still permitting easy installation and removal of a finishing element and securely holding the finishing element during use. The channel or groove and the second portion of the finishing element are configured to be complementary to the extent necessary. In the present example, the channel or groove includes a substantially planar bottom surface 206 and substantially straight, oppositely-facing sidewalls 208 extending substantially perpendicular to the bottom surface 206. However, in other examples, the channel walls can be slightly obtuse, for example approximately 3°, and the adjacent walls of the finishing element can be parallel thereto, such as described in FIGS. 13-14.

The bottom surface 206 of the channel as illustrated includes a ramp surface 210 (FIGS. 3 and 6-7), which in the present example is at the trailing or proximal end of the tool body. The ramp surface is configured to extend at an angle 210A relative to the adjacent planar finishing surfaces and provides clearance for and may also help to guide an opposite portion of the finishing element as the finishing element is being assembled on to the tool body for example as it is being angled in. In an alternative configuration, not shown, the proximal end of the bottom surface 206 may terminate in a shelf surface, recessed below but parallel to the bottom surface, rather than a ramp surface, for receiving a cubic-shaped gasket described more fully below.

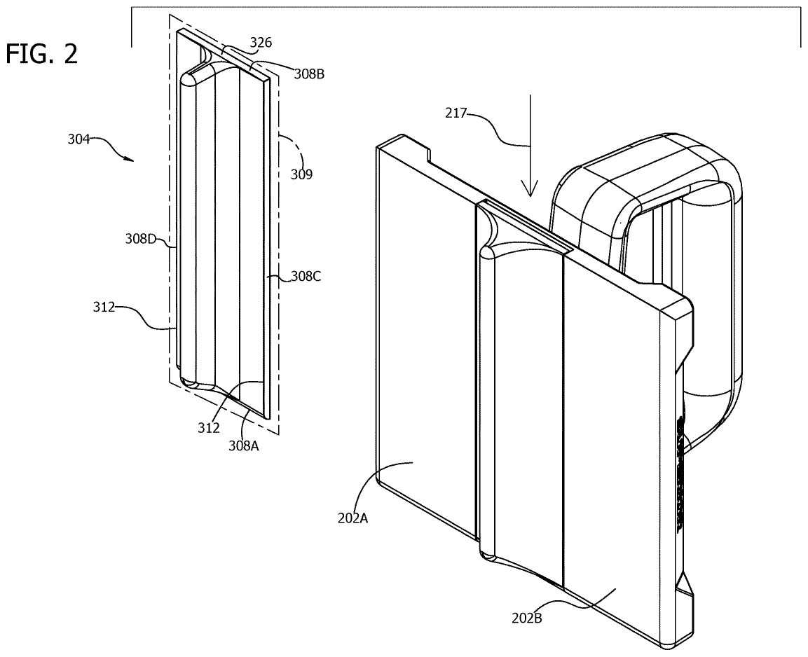

The tool body also includes a plurality of cavities for receiving projections on the finishing element. The cavities also include structures for engaging with the respective projections on the finishing element, for example to help guide the finishing element onto the tool body, and to reliably support the finishing element on the tool body during normal use. The first and second cavities can be substantially the same, but in the present examples, the first and second cavities are different, and the first cavity 212 is at a leading portion of the channel of the tool body, and the second cavity 214 is at a trailing portion of the tool body. The first cavity is sufficiently wide, long and deep to receive a securement projection of the finishing element, and in the present example includes an angled wall 216, in the present example facing forward in the direction of travel 217 (FIG. 2) and away from the bottom surface 206 of the channel 204. The angled wall helps to limit the finishing element from moving away from the finishing surface of the tool body, and helps to limit its movement in a direction rearward of the body.

The second cavity is formed adjacent the ramp surface 210, and in the present example partly in the bottom surface 206 though it can be formed otherwise in the bottom surface. The second cavity is configured to receive a second securement projection of the finishing element. In the present example, the second cavity is configured to help in arranging the finishing element so that the other projection can enter the first cavity, and so that the second projection can be reliably and removably secured in the second cavity. The tool body can have first and second securement elements, for example in the first and second cavities, that are substantially the same as each other, but in the present examples the first and second securement elements in the tool body are different. A securement element in the second cavity includes a movable latch element, movable so that the finishing element can be properly and fully engaged with the tool body, and a latch configuration so that the adjacent portion of the finishing element can be held in place during normal use.

The second cavity 214 is defined in part by a sloping surface 218, extending from an edge portion of the tool body adjacent the ramp surface 210 to an upper portion 220 of the tool body. The sloping surface 218 helps to receive and guide the second projection on the finishing element, helping the second projection to properly position laterally and to move forward toward a movable release element, described more fully below. Each of the sides of the cavity includes one or more guides 222 along the side walls of the cavity. In the present example, each guide, only one of which is shown in FIGS. 3, 6 and 7, is a ridge or guide bar extending substantially longitudinally within the cavity. The guides help in part to center the second projection on the finishing element in the cavity 214.

The second cavity also includes a securement portion, in the present example a release and/or releasable retention element or mechanism 224 (FIGS. 3, 6-7). The release mechanism may include a latch, a resiliently compressible bias, a resilient engagement or similar mechanism for helping to position and retain a portion of the finishing element in the groove 204. In the present example, the release mechanism includes a resiliently compressible element, presently in the form of a shaped plunger 226 biased rearwardly by a spring 228 that is retained in a cavity or counterbore 230 terminating at an end wall 232 defining a bore 234. In the illustrated configuration, the spring 228 is a helical compression spring, and is recessed below the finishing surface of the tool, interior to the tool body, but other configurations can be used to provide a resiliently compressible element.

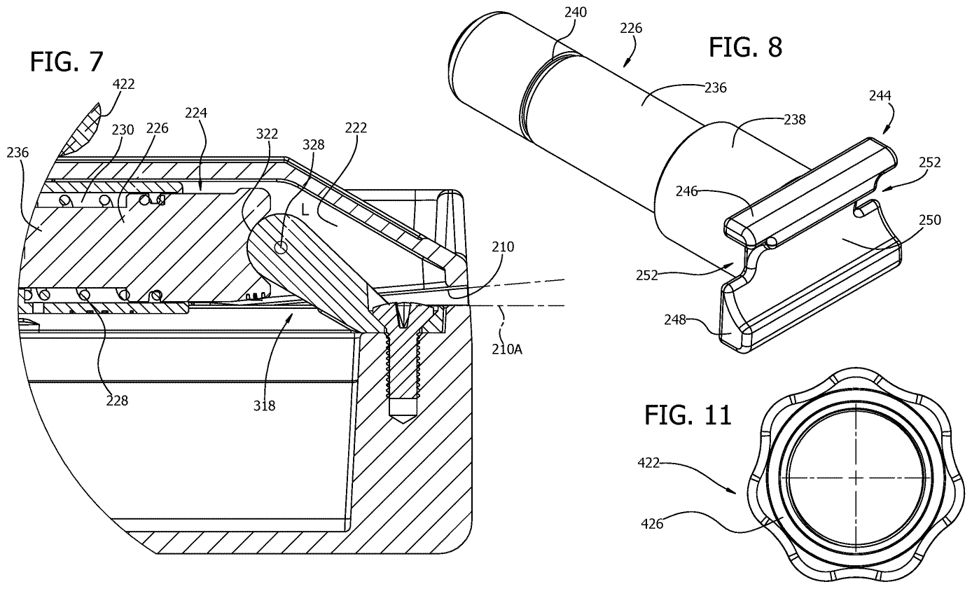

In the illustrated configuration, the shaped plunger 226 includes an axial shaft 236 (FIGS. 7-8) extending longitudinally within the coil spring 228, substantially parallel to the longitudinal axis of the tool body. The shaft includes a shoulder 238 for engaging an end of the spring 228 opposite the end wall 232. The shaft also includes an annular groove 240 for receiving a C-ring for retaining the shaped plunger in the bore 234. As illustrated, the end of the shaft also extends through an opening in a wall 242 (FIG. 6), to help guide the shaped plunger longitudinally/axially. The guide walls 222, end wall 232 and wall 242 help to limit lateral movement of the shaped plunger away from a central axis of the bore 234/counterbore 230.

The shaped plunger includes a shaped head 244. The shape of the head is configured to receive and allow pivoting of an adjacent projection on the finishing element. In the present example, the shaped head includes first and second spaced apart walls 246 and 248, respectively. The spaced apart walls define the end surfaces of a shaped seat 250. The shaped seat is configured in the present example to receive a complementary shaped projection on a finishing element, such as described more fully below, though they need not be complementary in all respects. In the present example, the shaped seat is a partially cylindrical wall having a center axis defining a radius of curvature wherein the center axis extends substantially parallel to the finishing surface 202 of the tool body and substantially transversely of the longitudinal direction of movement of the tool body. In this example, the center axis defining the radius of curvature for the partially cylindrical wall coincides with the pivot axis 328 when a finishing element is assembled with the tool body with the configurations described herein. As illustrated, the shaped seat faces away from the leading edge of the tool body.

The shaped head also includes guide surfaces. In one example, the shaped head can have at least one, and in the present example two oppositely facing channel walls 252. The channel walls help to guide the shaped plunger longitudinally in the bore 234, in the present example by following the guide walls 222 (FIG. 6). As illustrated, the present configuration of the channel walls is substantially U-shaped to have walls to extend above and below the guide walls 222. The guide walls help to limit pivoting or rotation of the plunger within the channel while still allowing the desired axial movement.

The first and second cavities 212 and 214 are contained entirely within the interior of the tool body, for example within a perimeter of the groove 204, where the perimeter is defined by the longitudinally extending side walls 208 and the end walls 253A and 253B, in the present example the leading and trailing edges, respectively, of the groove 204 (FIG. 3). In this configuration, the securement for any finishing element can be configured to be entirely contained within an interior of the tool body, and in the present example contained laterally and longitudinally within the perimeter of the groove. In the present example, the securement elements 216 and 224 are within the interior of the body and recessed below the finishing surface of the tool and also under the top exterior surface of the body. Additionally, in the example illustrated herein, having a configuration where the securement is entirely contained within an interior of the tool body, or within a perimeter of an area for receiving a base of a finishing element, the securement can be protected from the elements and the finishing element can be used on the work surface without having to account for the location of the securement. Furthermore, in the illustrated configurations, the securement elements 216 and 224 or other means for inter-engaging with the finishing element do not extend beyond a perimeter 202C of the finishing surface 202 (FIG. 3). Additionally, no part of the removable finishing element extends in the plane of and beyond a perimeter 202C of the finishing surface 202.

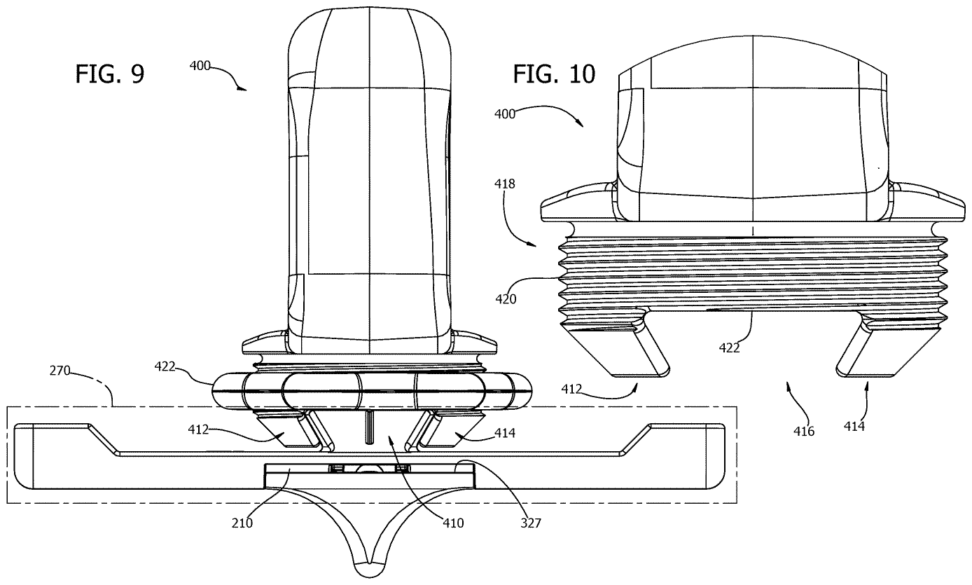

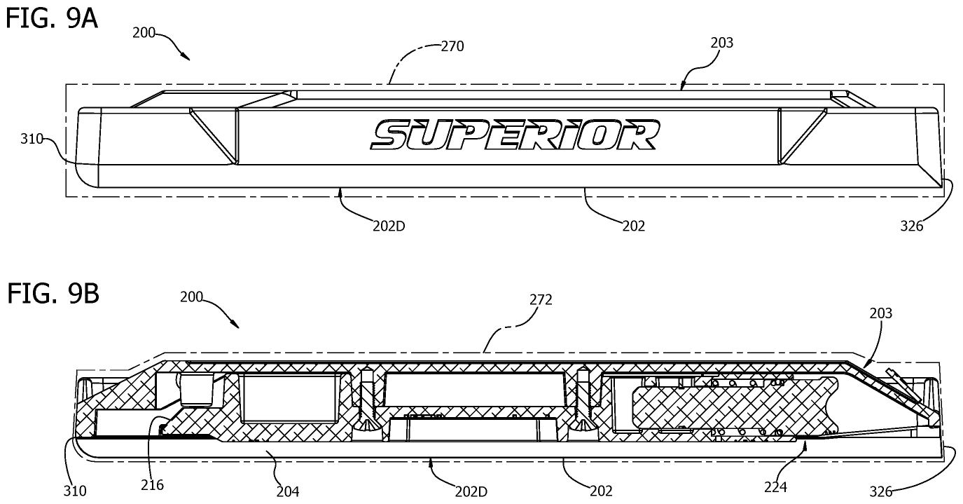

In the configurations illustrated herein, for example FIG. 9A, the tool body 200 is configured for receiving a removable concrete finishing element so that securement configurations are protected against the elements and interior to the assembly, and in the present configurations the securement configurations are not visible when the parts are assembled. The concrete finishing body portion 200D and the manual control mounting portion 203 define body surface portions defining a body envelope 270. In the present example, the body envelope is a three-dimensional space defined in length by the maximum distance in an X direction between the proximal 326 and distal 310 end surfaces of the tool body. The width is defined by the maximum distance in a Y direction between the lateral sides of the tool body, and the height is defined by the maximum distance in a Z direction between the finishing surface 202 and the uppermost surface of the attachment portion 203. The broken lines representing the body envelope 270 are spaced apart from the surfaces at maximum spacing for ease of illustration. In the configurations of the tool bodies described herein, at least one and in the present examples both engagement structures 216 and 224 for engaging respective components or projections on the removable concrete finishing elements have at least a portion that are interior to the body envelope. In the present examples, substantially all of both of the engagement structures 216 and 224 are interior to the body envelope. Therefore, where the engagement structure 224 is a compressible element, the compressible element is positioned interior to the body envelope. Similarly, where the compressible element is a foam material at the proximal end portion of the tool body, the foam material is positioned interior to the body envelope.

As illustrated in FIG. 9B, the concrete finishing body portion 202D and the manual control mounting portion 203 define body surface portions defining a body profile 272. In the present example, the body profile is a two-dimensional space defined in length by the distance in an X direction between the proximal and distal end surfaces of the tool body at a given height in the Z direction for a given plane in the Y direction. The broken lines representing the body profile 272 follow the surface profile in side view, while the broken lines are illustrated spaced apart from the actual surfaces for ease of illustration. The body profile is also defined in height by the distance in the Z direction between the finishing surface 202 and the top of the body portion or control mounting structure 203 as the case may be at a given position in the X direction for a given plane in the Y direction. In the present example in FIG. 9B, the plane in the Y direction is taken at the longitudinal or longitudinally extending centerline of the tool body. As can be seen in FIG. 9B, the body profile in side view has the concrete finishing side substantially straight. The engagement structures 216 and 224 are positioned widthwise within the groove 204, and they are recessed below the finishing surface 202. It also illustrates that they are positioned within the interior of the body profile 272.

The engagement structure 224, and more specifically the head of the shaped plunger 226, receives a projection on a finishing element such as 300 (FIGS. 3-8). In the illustrated configurations, the finishing element 300 is a blade for grooving concrete, but the use of the term “blade” is understood to include other finishing elements depending on the application for the tool, and the description of the illustrated example is not limited to blade components or geometries. As illustrated in FIG. 1, the tool body can be used with a plurality of blade configurations, namely the blade 300 and a narrower blade 302. An assembly or a kit including the tool body and/or a plurality of blades is useful to the user so that all of the desired blade configurations are easily available for any job (wider, deeper, different curvatures or other surface geometries or configurations, or for creating or shaping different constructions). For example, each blade would have a geometry with a defined depth, angle, width and radius for producing the desired groove configuration in the concrete, or other finishing elements will have their respective geometries, and each of the elements can be used with the single tool body. In one example, each blade has a first portion with the defined geometry, and a second portion having a base supporting the structure of the defined geometry, and wherein the second portion includes structures that are identical or substantially identical to each other as between different blades and where such structures are used to engage appropriate and preferably complementary portions of the tool body. In the present example, all of the blades have substantially identical base structures and geometries. However, it is understood that parts of the base structures and their geometries may be different while other structures on the base of the blade are sufficiently the same to reliably position and secure the blades to the tool body so that the blades are interchangeable on the tool body. Therefore, a variety of blades or other finishing elements can be reliably supported on a given tool body even though all portions of a base of a finishing element are not identical to those of other finishing elements.

In the illustrated configurations, each blade 300, 302 includes a second portion forming a base 304, and in the illustrated examples, each of the bases 304 are substantially identical, and only one will be described in further detail. A plurality of such finishing elements can form a kit or assembly, for example for use on a single base, and the kit can also include the tool body to which they can be attached. Each base has attached to it the first portion of the blade attached to the base in the form of a finishing structure 306, and the finishing structure has the depth, angle, width and radius for the desired tool geometry, and will not be described in further detail. As noted elsewhere, the tool geometry can take a number of configurations, depending on the function of the tool, for example grooving, edging, and the like, but the present examples will be directed to blades for grooving. As illustrated, the finishing structure is asymmetric longitudinally, but it can be symmetric, as desired, including with substantially vertical leading and trailing edges.

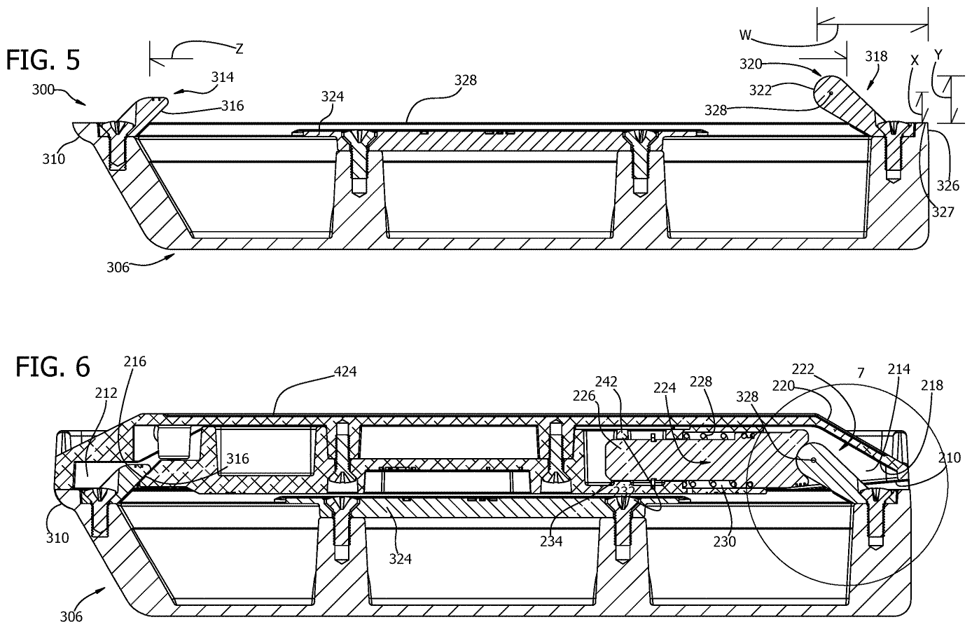

The base includes a substantially planar platform 308 having an outer perimeter geometry substantially complementary to the perimeter of the groove 204 in the tool body. In the illustrated configuration, the planar platform is substantially rectangular with front, back and side dimensions approximating those of the groove 204. The outer perimeter geometry of the base is defined by the sidewalls, in the present example substantially straight leading, trailing and lateral walls 308A, 308B, 308C and 308D respectively, defining the perimeter, and the sidewalls/perimeter define a plane 309 (FIG. 2) which in the present example is parallel to the plane of the finishing surface and substantially co-planar with the bottom surface 206 of the groove 204. The leading outside or distal surface 310 (FIGS. 5-6) of the base may be radiused or otherwise modified to lead in or transition to the structure of the blade 306. The platform 308 of the base is also selected to have a thickness, when the blade is fully seated in the groove 204 and secured in place, whereby the surfaces 312 in the base 304 (FIGS. 2 and 4) adjacent the portions of the tool finishing surfaces 202 adjacent the groove 204 are substantially co-planar or flush with each other. Therefore, the surfaces are configured in these examples to give the appearance as though the blade is not a separate element from the finishing surface of the tool body, and no securement elements for securing the blade on the tool body are visible. Additionally, the spacing between the base 304 and the adjacent walls of the groove 204 are as close as reasonably possible to provide a perceived seamless transition between the surfaces. It may be desirable for the radius of the blade to be such that the adjacent surfaces between the blade and the finishing surfaces are coplanar or flush.

In the present examples, the blades are releasably mountable on the tool body. In one configuration, the base of the blade can have first and second engagement or securement elements for engaging securement structures in the cavities in the tool body to securely hold the blade relative to the tool body. In the illustrated examples, the engagement or securement elements extend outward of the finishing elements, and are raised from the plane 309 of the base in a direction away from the finishing portion of the blade. For example, the blade base includes a first projection 314, for example a clip, at a leading or distal portion of the base of the blade. The first projection 314 includes an angled surface 316, in the present example extending along and contacting the angled surface 216 in the first cavity 212. The angled surfaces 216 and 316 help to secure the blade in place on the tool body. They are selected such that forward motion of the tool encourages the angled surfaces together. In the illustrated configurations, the angled surfaces 216 and 316 are configured to make surface contact, as opposed to edge or line contact, and extend at substantially the same angle to a horizontal. However, such extended surface area of contact is not required. The size of the cavity 212 and/or the longitudinal positioning of the angled surface 216 in the present example is selected to allow the first projection 314 to move in the cavity 212 while the base of the blade is flush against the base of the groove sufficient for the first projection to clear the angled surface 216, allowing the leading portion of the blade to pivot away from the tool body.

A second engagement or securement element in the base of the blade engages the second cavity 214 in the tool body. In the illustrated configuration, the second engagement or securement element is a second projection 318 extending at an angle to a horizontal plane (parallel to the finishing surface 202 and the oppositely facing surface of the base 304) similar but opposite to the angle of the first projection 314. The second projection includes an end portion that is a seating element 320. The seating element 320 includes at least in part a surface complementary to the geometry of the seat 250 in the shaped plunger 226. The seating element includes an arcuate surface 322 for engaging the arcuate surface in the head of the shaped plunger of the retention element. In the illustrated configuration, the portion of the seating element 320 and a portion of the seat 250 that come into contact with each other are substantially complementary, and in the present example form partially cylindrical surfaces that reliably engage each other. The arcuate surface 322 is a rounded convex surface. In another example, the seating element could be partly spherical or other curved shape that could contact the corresponding securement element in the body. The width of the second projection is less than the spacing between the guide walls 222, for example sufficient to allow the second projection to be guided along the ramp surface 218 and between the guide rails 222. As can be seen in FIGS. 4-7, the projections 314 and 318 in the present example are formed on the same structure 324 in the base (FIGS. 4-6). With such a configuration, the structure 324 will be known to reliably engage the tool body and the same structure configuration can be used on all of the different blade configurations for releasably mounting any of the blade configurations on the tool body. Alternatively, the projections or other securement elements can be formed monolithic with the rest of the finishing element, such as by molding or otherwise.

To assemble a blade on the tool body, the trailing end of the blade and the second projection 318 are angled to the groove 204 so that the trailing end of the blade contacts the ramp wall 210, and the second projection 318 guided between the guide walls 222. When the seating element 320 contacts the seat 250, the blade is advanced forwardly to compress the spring 228 until the first projection 314 can extend into the cavity 212; the first projection can be slid along the groove 204 until it enters the cavity 212. When the first projection 314 extends into the cavity 212, the base 304 of the blade is sufficiently or fully inserted into the groove 204 of the tool body until the base contacts the bottom surface 206 of the groove 204. The blade can then be released to allow the compression spring to push the plunger and the blade rearward so that the angled surface 316 contacts the angled surface 216, and the spring and plunger hold the second projection and the blade in place. The hand groover can then be used in a normal fashion. To remove the blade, the blade is advanced in a forward direction to compress the spring 228 until the first projection 314 clears the angled surface 216 and can be removed from the cavity 212. Thereafter, the second projection 318 can be removed from the cavity 214. A blade can be installed in approximately one second or less. An alternative or replacement finishing element can then be assembled on to the tool body, and secured in the same manner as the previous finishing element was secured.

For a given securement configuration in the tool body, it is desirable that the first and second projections on the various and assorted finishing elements have substantially the same spacing between them and/or between them and the base 304. For example, it is desirable that each of them have the same or substantially the same distance W between the forward-most or distal-most surface on the seating element 320 and the proximal-most or end surface 326 of the base (FIGS. 2 and 5). This helps to allow each finishing element to compress the spring 228 sufficiently to install the element on the tool base and also to sufficiently compress the spring once the element is installed to hold the angled surface 216 against the angled surface 316 in the first cavity 212. It is also desirable that each of them have the same or substantially the same distance X between the base surface 327 of the element at the end surface 326 and a center 328 of the seating element 320. In the illustrated configuration where the seating element 320 has a substantially cylindrical surface 322, the center 328 represents a transverse axis about which the finishing element pivots when in contact with the seat 350 of the plunger (see FIGS. 4-7). This helps to reliably seat the finishing element in the groove of the body and allow the desired pivoting when the element is being installed and removed, for example as the base surface 330 (FIG. 4) approaches the ramp surface 210 (see FIG. 7). It is also desirable that each of them have the same or substantially the same distance Y between the base surface 330 (for example as it may define a plane containing the upper surface of the finishing element illustrated in FIG. 4) and the top of the seating element 320, farthest from the base surface 330 in a direction normal to a plane containing the base surface. This helps to ensure the desired engagement between the seating element and the plunger. Additionally, it is desirable that each of them have the same or substantially the same distance Z between the first and second projections at the respective levels of the angled surfaces in the plane of the base surface. This helps to have the desired engagement between the angled surfaces 216 and 316 and the desired compression of the spring 228 for the desired engagement.

As illustrated in FIGS. 3 and 5-7, the pivot axis 328 of the second projection 318 when engaged with the plunger 226 defines a pivot axis, presently the pivot axis 328, that is recessed below the base 206 of the groove 204. Consequently, the pivot axis for the finishing elements when engaging with the tool body is recessed away from the finishing surface 202, and also does not intersect the finishing surface of the tool. Additionally, the pivot axis is interior to the tool body, positioned between the finishing surface 202 and the top of the tool body, which in the illustrated examples is formed by the top surface 410 of the tool body housing, described more fully below. Having the pivot axis portion of the securement for the assembly interior to the tool body helps to protect the securement from the elements, and also allows the user to use the tool assembly without regard to the location of securement elements. It also extends transversely of tool body. It is noted that other surface configurations between the second projection 318 and its receiving surface, in the present example the shaped seat 250, can produce a configuration having a pivot axis within a perimeter of a groove in the tool body surface, below the finishing surface of the tool and/or interior to the tool body.

In the illustrated examples, the tool having a finishing surface on the first side of the planar tool body is configured to receive a handle or pole attachment element on a side of the tool body opposite the finishing surface. In the present examples, the attachment element is raised from the planar tool body in a direction opposite the direction in which the finishing surface faces. The attachment element may be a solid structure or, as illustrated in the present examples, as a recessed or hollow portion in the form of a plurality of cavities within which securement elements of a finishing element are received and secured by suitable securement elements in the tool body. In the illustrated configurations, the attachment element is a dovetail allowing longitudinal adjustment of a handle or pole on the tool body, and for movably receiving a handle or pole attachment for reliably securing the tool body and handle or pole attachment together.

The handle for the groover can take a number of configurations, including a hollow or closed-frame handle as illustrated, or an offset straight handle also called a cantilever handle discussed herein, or other configurations. In one example, the handle may be a hollow rectangular handle, a four-sided handle with a single slanted wall, or with two slanted walls as illustrated in FIGS. 1-2. The handle 400 has a generally trapezoidal shape with first and second portions in the form of first and second angled side walls 402 and 404 extending between third and fourth portions in the form of an attachment wall 406 and a grip wall 408. The sidewalls 402 and 404 extend at respective acute angles to the bottom of the handle, or at an acute angle 409A relative to a line 409B normal to the finishing surface, and at obtuse angles to the top of the handle. The sidewalls are angled so that the tool body can be placed on a surface with either the leading edge of the tool body resting on the surface and the leading sidewall 402 also resting on the surface in a stable configuration, or the trailing edge of the tool body can rest on the surface and the trailing sidewall 404 can rest on a surface in a stable configuration. The sidewalls 402 and 404 have a width that is about 50% or more of the height of the grip wall 408 above the nut 422 or the bottom of the attachment wall 406. The larger handle width helps to provide a more stable resting position when the tool is placed on the sidewall. This positioning helps to preserve the finishing surfaces on the blade and the tool body surface.

The handle 400 can be permanently mounted to an upper surface of the tool body, or the handle can be removable. In the illustrated configuration, the handle 400 is adjustably and removably mounted on an upper surface of the tool body. In the present example, the tool body includes a longitudinally-extending structure that can be used to provide an engagement with the handle where the engagement can be placed in tension. As illustrated, the longitudinally-extending structure is a dovetail 410 (FIGS. 1 and 9) extending almost the length of the tool body. In the illustrated configuration, the longitudinally extending structure is substantially centered widthwise or transversely of the upper surface of the tool body, but may be positioned elsewhere with respect to the tool body. The handle may include an integral or separate interface structure with a complementary surface or surfaces for engaging the structure on the tool body for producing an engagement under tension. The complementary surface or surfaces can take a number of configurations, but in the present example the handle includes complementary dovetail groove elements 412 and 414 defining a dovetail groove 416 (FIG. 10). The dovetail groove fits over and provides a complementary geometry to the dovetail 410, and the dovetail groove allows the handle to be slid over the dovetail from the front or back of the tool body, for installation and for positioning the handle on the tool body as desired. Placing the engagement between the dovetail 410 and the dovetail groove 416 under tension can occur in a number of ways. In the illustrated configuration, the handle 400 includes a securement body 418 between and integral with the handle 406 and the dovetail groove elements 412 and 414. In the present example, the securement body 418 is a threaded structure 420 for receiving a complementary threaded nut 422 (FIGS. 1, 7, 9 and 11). As illustrated, the threaded structure is a cylindrical base with the external threads extending at least partly onto the dovetail groove elements 412 and 414. The lower-most extent of the threads is lower than the upper surface 422 of the dovetail groove 416, so that threading of the nut away from the handle can securely contact the top of the dovetail 410 within the dovetail groove 416. Alternatively, surface configurations may be used to place the engagement in tension where the surfaces are not all complimentary.

The top surface 424 of the dovetail 410 is not insubstantial, and provides a significant amount of surface area for contact by the nut 422. Additionally, the annular surface area of the nut provided by the difference between the inside diameter and the outside diameter of the nut also includes a significant surface area to provide a significant surface area of contact between the nut and the upper surface of the dovetail. Higher surface area of contact provides for a more secure and reliable mounting of the handle on the tool body, and a more stable feel for the user. A higher surface area of contact also reduces the likelihood that the nut would thread away from the upper surface of the dovetail.

In the illustrated configuration, the nut 422 includes a non-circular perimeter, for example undulations, for easy gripping. Additionally, in one configuration, the nut 422 is metal and includes a washer 426 of a different material from the nut. The washer provides additional friction inhibiting rotation of the nut on the top surface 424, and has a higher coefficient of friction than the nut. The washer is formed from PA6 with a glass fiber content of about 30% for compressibility and friction characteristics, but other materials can be used, including for example nylon and similar materials. The washer is raised from the adjacent surface of the nut to ensure the desired contact with the top surface of the dovetail.

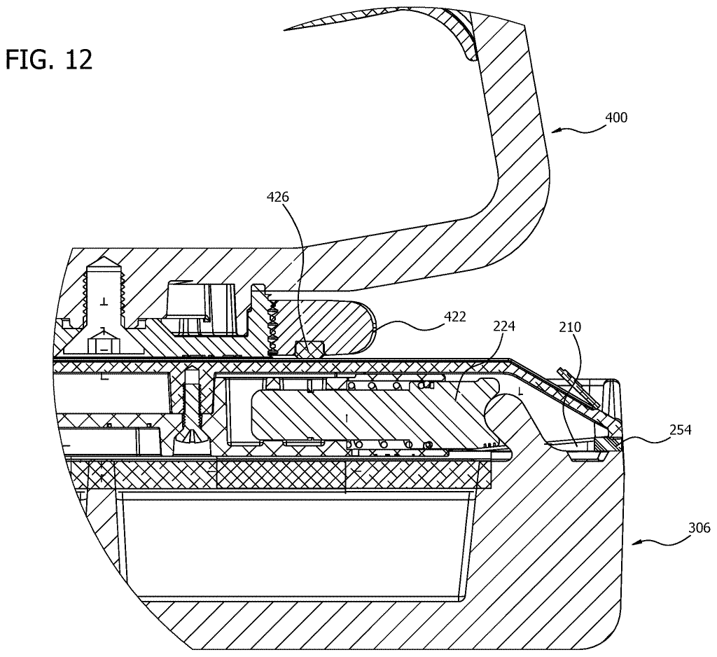

In the example illustrated in FIG. 12, the tool includes a compressible element between a portion of the tool body and a portion of the removable finishing element. In this example, the compressible element is a foam or other resilient material forming a gasket 254 that can be compressed when the finishing element is installed on or removed from the tool body. As a nonmetal material, the gasket has different properties than the adjacent structures, such as the tool body. The gasket can also help to keep debris out of the interior of the assembly and extends the width of the second cavity 214 or the width of the groove 204.

Various components of the assemblies can take a number of configurations alternative to those described herein. In one example (FIGS. 13-14), the dovetail securement body 418A interface between the handle and the attachment structure may include a more substantial cylindrical body below the threads 420 with the dovetail walls 412 (FIG. 9-10) interior to the cylindrical body.

Any of the handles described herein can also include a plastic material on the portion of the handle to be gripped by the user. In one example as illustrated in FIG. 13, the handle includes a cap or cover 426 at least partially and in the present example completely encircling at least a portion of the handle, for example the portion of the handle most easily accessible to the user for gripping. The cover may be formed from PA6 and may include approximately 30% glass fiber, or the cover may be formed from other comparable materials for grip and/or durability.

Any of the tool bodies having a groove 204 with a base surface 206 (FIG. 14) can have sidewalls 208 with a draft to make easier the assembly of a removable finishing element into the groove. The draft may be approximately 3%. Similarly, the base of the removable finishing element may also include a comparable draft in the sidewalls, for example approximately 3% relative to the base wall 327 to produce an angle 352 for an extension 354 of the base sidewall relative to a line parallel to the base surface 327. The lines 254 and 354 extending from their respective surfaces would be approximately parallel.

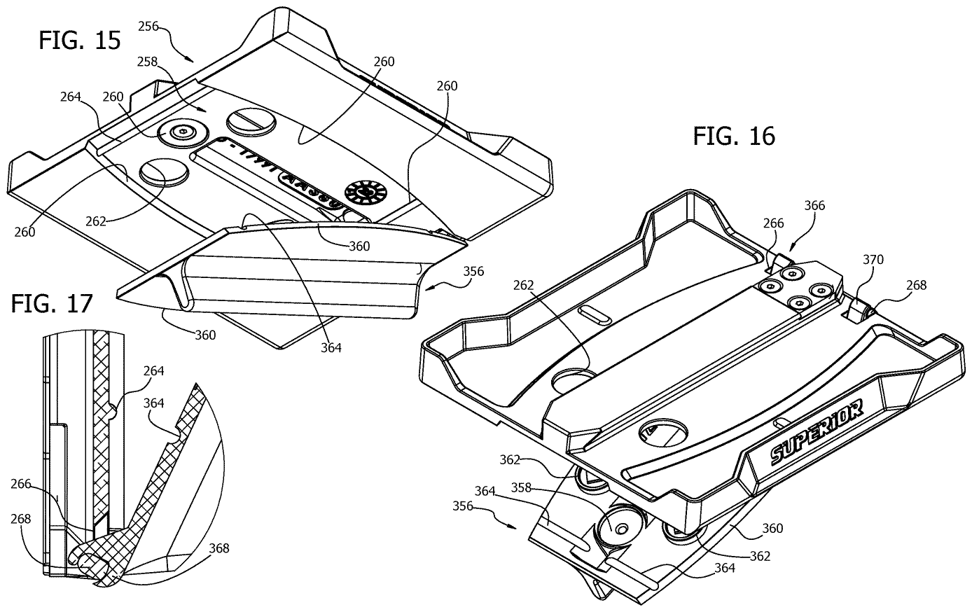

Another example of a finishing tool body uses alternative structures for helping to releasably retain a removable finishing element. In one example (FIGS. 15-17), a tool body 256 includes a recess 258 for receiving one or more (alternately) removable finishing elements 356. The tool body includes a releasable retention element in the form of at least one magnet 260 for attracting a magnetically sensitive element closer to the tool body. The magnet 260 is positioned in the recess 258, and in the illustrated example, centered widthwise of the recess, at a rearward portion of the tool body.

The magnetically sensitive element is on an opposite facing surface of the removable element 356, and may be a magnet and in the present example is a steel disc 358.

The removable element 356 is releasably retained on the tool body, and in the present example in the recess of the tool body, using at least one, and in the present example several barrier structures to help properly position and retain the removable element in place. The barrier structures can be walls, lands and grooves, bosses and cavities or openings, and other structures and geometries. For example, the removable element includes convex lateral sides 360 for nesting in and being retained in part by complementary concave lateral sides 260 in the recess of the tool body. In one example, both sets of sidewalls have complementary drafts, for example approximately 3°. The removable element also includes a plurality of bosses 362 for fitting in complementary openings 262 in the recess of the tool body. The removable element also includes a plurality of grooves 364 for receiving complementary lands 264 in the tool body. Other complementary surface structures may be used in addition to or in place of any one or more of the surface structures on the tool body and element for helping to retain the removable element in place during normal use. Additionally, any of the structures can be reversed or inverted to provide a reliable retention configuration.

The removable element also includes at least one and in the present example two hooks or fingers 366 at a leading end portion of the removable element for engaging openings 266 in a portion of the recess opposite the hooks. The hooks are identical and description of one gives information for the assembly. The hook 366 in cross-section includes a proximal finger 368 and a distal finger 370 defining an elongate opening between them. Each finger has a concave surface facing the other finger connected between them by a substantially straight wall. The fingers and the straight wall define an opening having a widest dimension smaller than a maximum distance between the fingers. The opening receives and allows the hook to contact and slide over a cam 268 (FIG. 17) for pivoting the removable element into engagement with the tool body and helping to releasably lock the removable element in place when the base of the removable element is secured in the recess 258 of the tool body. The cam has a substantially oval cross-section with a primary axis extending between curved walls having unequal radii of curvature and a secondary axis extending between substantially parallel sidewalls. The primary axis extends upward and to the left as seen in FIG. 17 at an acute angle to the end of the tool body. As the removable element pivots toward the recess of the tool body, the distal finger extends around the adjacent curved surface of the cam (shorter radius of curvature) and is locked in place longitudinally and downwardly into the recess by the cam when the removable element is fully seated in the recess.

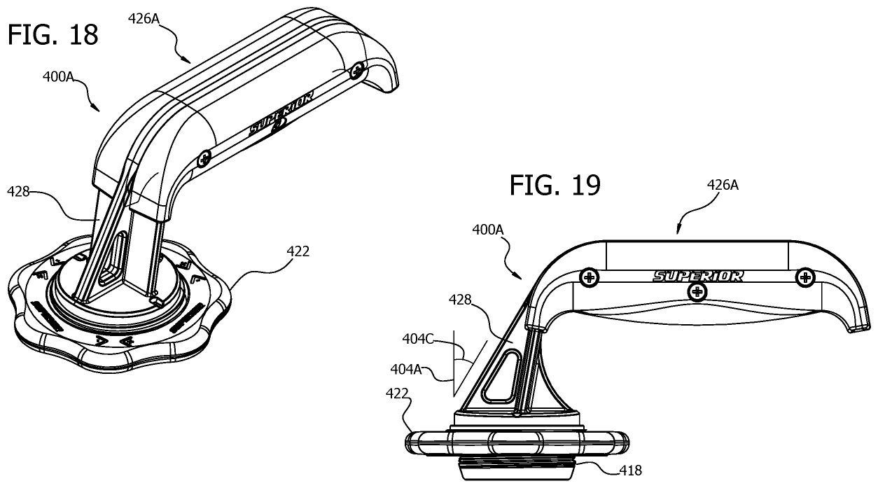

In another handle configuration, an adjustable and removable handle 400A (FIGS. 18-19) is in the form of a cantilever handle and is removable and adjustable along the tool bodies in the manner described herein. The handle includes an interface assembly having a dovetail configuration in the body 418 and is secured on a dovetail structure on the tool body with the nut 422. A gripable material cap or cover 426A is placed over a handle frame 428 for ease of gripping the handle. The handle has a height from the nut and a width at the cap or cover that is about half or more of the height, to improve the stability when the tool is placed with the handle frame 428 facing downward toward a support surface.

In use, a removable handle (or pole) would be slid over the dovetail on a tool body with the dovetail groove 416 covering the adjacent part of the dovetail. When the handle is positioned as desired, the nut 422 is threaded down against the top surface of the dovetail. Contact is made between the nut and the dovetail at two areas, in front and behind the handle, and the area of contact extends across the width of the dovetail. The handle position is adjusted when the nut is loose by moving the handle or pole along the dovetail structure (see 430 in FIG. 1). The handle is removed by reversing the process.

The tool body can also include a direction indicator, such as a pointer 269 (FIG. 1), an arrow or the like for giving a visual indication for someone above of the recommended direction of travel consistent with a rounded leading surface on the finishing surface of the tool body (illustrated in FIGS. 9A and 9B), and in the present example also indicating the centerline below of the blade. In the present example, the pointer is formed as converging surfaces in the dovetail 410.

The components of the hand groover or other concrete hand tool can be formed from a number of materials, including those previously discussed. In the present examples, the handle can be plastic and the nut 422 can be diecast aluminum or PA6-GF30 material. The tool body, blade mount structure in the tool body and plunger may be diecast aluminum for rigidity, wear resistance, weight and smooth surfaces, and the mounting structure in the removable components, and the rest of the removable components can be PA6-GF30 plastic for stiffness and wear resistance, or they can be die cast aluminum.

The mounting structure for the removable element for being secured in the tool body can be formed from a single structure, or monolithic, for example so that the mounting structure extending from the first cavity 212 to the second cavity 214 is on or part of one structure. Additionally and/or alternatively, the structure that engages it, from the first projection 314 to the second projection 318 can also be formed from a single, monolithic structure.

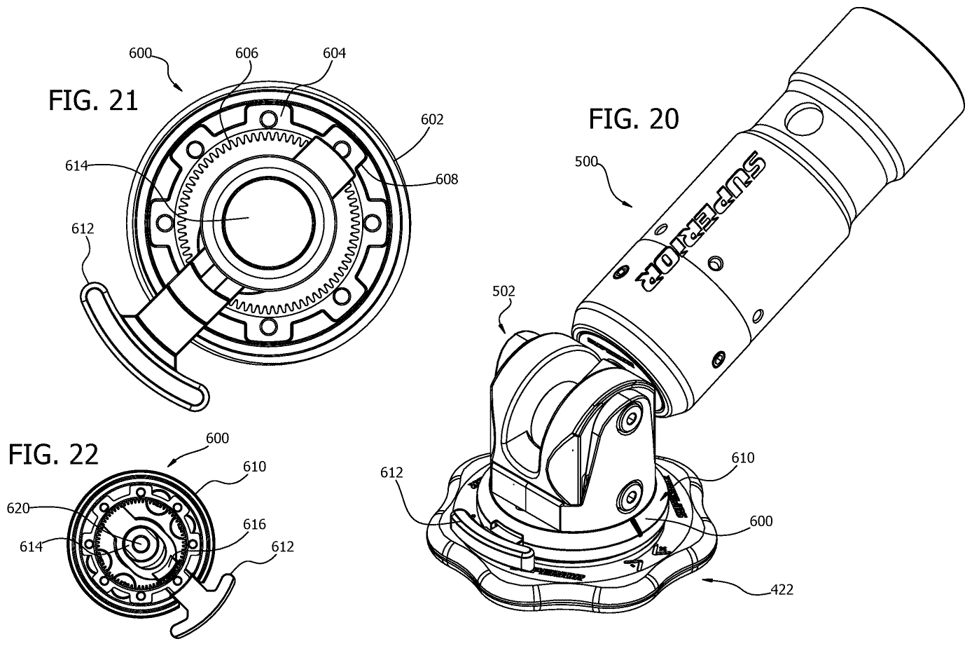

In another example of a control structure for a finishing tool, a control structure in the form of a pole attachment 500 (FIG. 20) can be releasably secured on any of the tools described herein, and can be adjustable on the tool in the same manner as previously-described handles are releasably secured and adjustable. The pole attachment 500 can be mounted on the same securement body 418 or 418A (not shown in FIG. 20) and the underlying securement body may have a dovetail groove as described herein or other securement configuration for a tool than a dovetail, whether removable or fixed. Therefore, control structures for finishing tools can take a number of configurations such as the handles and pole mounts described herein.

In another apparatus for use with manual tools, including manual concrete finishing tools described herein, and/or with any of the control structures described herein, a releasable locking interface assembly, in the present example turret assembly 600 (FIGS. 21-23), can be used to provide additional degrees of freedom for positioning control structures on manual tools, and in the present examples positioning handles or pole mounts on concrete finishing tools. Specifically, the turret assembly 600 allows control structures to be placed at selected pivot angles in a horizontal plane relative to the manual tool, and in one example the turret assembly allows selected angles in 45° increments, and in another example the turret assembly allows selected angles down to 5° or 10° or other increments, as a function of the structure of the assembly.

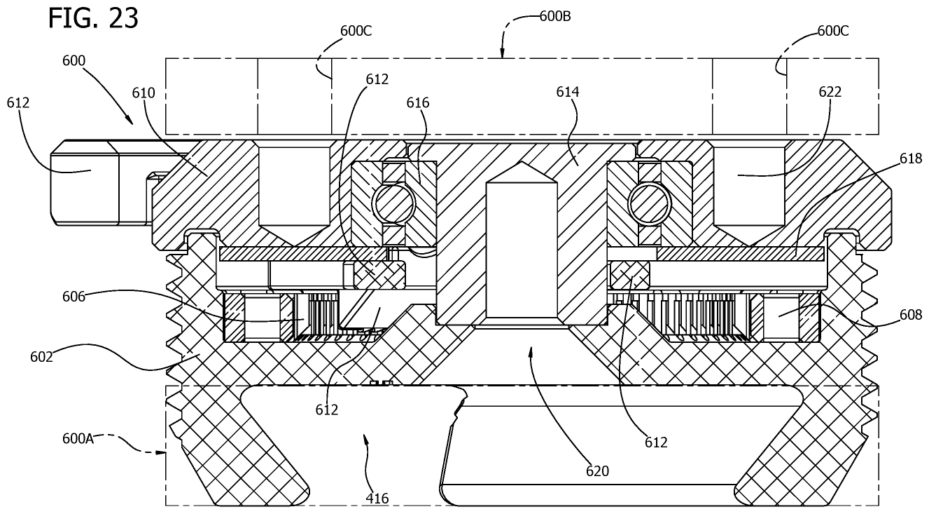

A base 600A of the turret assembly is configured to be engageable with a control mounting structure on a manual tool. The base 600A is shown generically by broken lines because the base may be formed integrally with the turret assembly 600, in the manner as illustrated in FIG. 23 and described more fully below, or the base may be formed separately and mounted, secured or otherwise supported on the turret assembly. The base is also shown generically because the configuration of the base will typically be dictated by the form of the control mounting structure on the manual tool. The base would be mounted, secured or otherwise supported on a surface of the turret assembly preferably configured so that the upper portion of the base would be substantially planar, for example so that pivoting with the turret assembly would move the base generally in a plane. For example, in the illustrated example, the turret assembly could have flat surface on the bottom of the turret assembly corresponding to the upper broken line in 600A in FIG. 23, and the flat surface defines a plane parallel to a plane in which the turret assembly pivots.

The turret assembly 600 will be mounted, secured or otherwise supported on a control structure 600B. The control structure can be any handle or pole or other control structure such as those described herein or similar control structures. The control structure can be mounted to the turret assembly through fasteners or other components through suitable openings 600C into securement openings such as tapped structures in the turret assembly described more fully below. Other securement means for securing a control structure to a releasable locking interface assembly can be used, as desired. In the illustrated configuration, the control structure would be mounted to a flat surface on the turret assembly, on a side opposite the base 600A so that pivoting of the turret assembly would benefit the control structure substantially in a plane coplanar with the plane in which the turret assembly pivots.

The turret assembly 600 includes upper and lower assemblies or bodies join together and configured to be selectively pivoted relative to each other. In the illustrated configuration, the assembly 600 includes a lower housing 602 supported on and secured to the dovetail structure (FIG. 23), and in the example illustrated the lower housing 602 is formed as part of or integrated into the dovetail structure forming the dovetail groove 416, though it need not be. The lower housing and the dovetail structure or other base 600A are pivotally fixed relative to each other. In this example, the lower housing 602 is configured to be similar to the securement housing 418 or 418A and engage a control mounting structure in a manner similar to that described herein with a suitable nut 422 or other comparable securement. The structures and functions of such engagement between a dovetail groove and a dovetail structure are substantially the same as described herein. However, other control mounting structures can be used as desired.

The lower housing 602 supports and secures a circular indexing or gear plate 604 having internal teeth 606, in the present example having a sufficient number to allow pivoting adjustment in 5° increments in the plane of the finishing tool on which the turret assembly 600 is supported. The gear plate can be secured against rotation by fastener openings in the gear plate or by inter-engagement between perimeter tabs 608 on the outside of the gear plate engaging complementary surfaces in the housing.

In an alternative configuration (not shown), the circular indexing plate 604 can omit the gears 606, while including a selected number of tabs 608. In the configuration illustrated, the indexing plate includes eight tabs, which allows the indexing plate to be lifted out of the complementary surfaces in the housing and turned in 45° increments and repositioned into the complementary surfaces and secured in the new position. Other tab configurations can be used, with the number and distribution determining the pivot increments. In a further alternative configuration, the circular indexing plate can include the gears 606, but the releasable pivot locking arm (described below) can be omitted in lieu of manually lifting the circular indexing plate and repositioning it in the complementary surfaces in the housing. The circular indexing plate can be accessed by removing a fastener and separating the lower housing from an upper housing 610. The circular indexing plate can be shifted, replaced, and the upper and lower housings joined and fastened together as before.

The releasable locking turret assembly 600 also includes an upper housing 610 (FIG. 22) to which is secured or otherwise supported a suitable control element. In the present example, the upper housing 610 is fixed to the pole pivot 502 through fasteners as described below, and the upper housing is pivotally fixed relative to the pole pivot or other control element. The upper housing supports a releasable pivot locking arm 612. The pivot locking arm is substantially rotationally fixed relative to the upper housing but is resiliently radially movable around a swivel pin 614 against a bias that returns the pivot locking arm. In its resting configuration, the pivot locking arm engages a plurality of teeth on the gear plate 604 with a plurality of teeth on a base structure 616, in the present example 3 teeth, to pivotally lock the control structure and tool against rotation in a horizontal plane (with reference to a horizontal work surface). When the pivot locking arm is moved radially (depressed by a user) the teeth on the base 616 disengage from the teeth 606 on the gear plate 604, thereby allowing the upper housing and control structure to pivot relative to the lower housing and securement body, as well as any tool that may be supported thereon. When the pivot locking arm is released, it returns to the configuration illustrated in FIG. 22 so the teeth can engage the teeth on the gear plate, thereby locking the upper and lower housings relative to each other.

The upper housing 610 includes a bearing assembly 616 sandwiched between it and a bearing retainer plate 618 (FIG. 23). The bearing assembly allows the upper and lower housings to rotate relative to each other through the spindle 614 secured to the lower housing through a fastener in the countersink and tapped opening 620 into the spindle. The pole pivot in the present example is secured to the upper housing 610 through fasteners received in the tapped openings 622.

The pivoting assembly for pivoting in the plane of the tool or worksurface can also be incorporated into any of the handle configurations described herein as well as other handle configurations that can be used on finishing tools, whether such tools have removable/interchangeable components or are conventional tools with fixed finishing configurations. For example, with hand tools with conventional handles or the handles as described herein, the user can pivot the handle to give a more comfortable working configuration. In the present configuration, the handle can be pivoted in 5° increments, but other configurations can provide smaller or larger increments, as well as pivoting over 360°. With or without the gears 606, larger increments such as 45° increments can be implemented using the desired indexing plate and corresponding support configuration in the lower housing.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A manual concrete finishing tool body configured to receive a removable concrete finishing element, the body comprising a concrete finishing body portion and a manual control mounting portion wherein the finishing body portion and the manual control mounting portion define body surface portions defining a body profile in side view relative to a longitudinal direction of movement, at least one engagement structure configured for engaging a component on a removable concrete finishing element wherein the at least one engagement structure has at least a portion of the structure interior to the body profile.

2. The tool body of claim 1 wherein the finishing body portion defines a side of the body profile in side view and the side of the body profile is substantially straight.

3. The tool body of claim 2 wherein the side of the body profile is defined by a side of the concrete finishing body portion.

4. The tool body of any of the preceding claims 1-3 wherein the at least one engagement structure is positioned in a groove in the concrete finishing body portion.

5. The tool body of claim 4 wherein the groove is formed in a finishing surface of the concrete finishing body portion and the at least one engagement structure is recessed below the finishing surface.

6. The tool body of any of the preceding claims 1-5 wherein substantially all of the at least one engagement structure is positioned within the interior of the body profile.

7. The tool body of any of the preceding claims 1-6 further including a compressible element interior to the body profile.

8. The tool body of claim 7 wherein the compressible element includes a spring.

9. The tool body of claim 7 wherein the compressible element is formed from a plastic material.

10. A manual concrete finishing tool body configured for receiving a removable finishing element, the body comprising a finishing surface extending in at least two dimensions wherein the body is configured for receiving the removable finishing element into a recess formed in the finishing surface.

11. The tool body of claim 10 wherein the finishing surface is substantially planar and the recess is formed into the planar finishing surface.

12. The tool body of any of the preceding claims 10-11 wherein the recess is a groove or channel formed in the finishing surface.

13. The tool body of any of the preceding claims 10-12 wherein the recess is formed with a substantially rectilinear opening.

14. The tool body of claim 10 wherein the finishing surface includes side walls defining a perimeter for the finishing surface and wherein the recess is formed at least partly within the perimeter.

15. The tool body of claim 14 wherein the perimeter includes two substantially parallel sidewalls and wherein the recess is formed interior to the parallel sidewalls.

16. The tool body of any of the preceding claims 14-15 wherein the perimeter includes substantially opposite side walls wherein the recess extends substantially an entire distance between the opposite side walls.

17. The tool body of any of the preceding claims 10-16 wherein the recess is configured so that a portion of a finishing element can be positioned so that the portion is recessed below the finishing surface.

18. The tool body of any of the preceding claims 10-17 further including a securement element within the recess formed in the finishing surface.

19. The tool body of claim 18 wherein the securement element includes at least one of a latch, magnet, hook, clip, and angled wall.

20. The tool body of claim 19 wherein the body includes a guide for positioning the securement element in the tool body.

21. The tool body of any of the preceding claims 19-20 wherein the securement element includes a seat for receiving a portion of the removable finishing element.

22. The tool body of claim 21 further including an angled wall facing a direction different than a direction in which the seat faces.

23. The tool body of any of the preceding claims 19-22 wherein the tool body includes an angled wall for receiving a portion of the removable finishing element.

24. The tool body of any of the preceding claims 10-23 further including a pivot surface formed within the recess wherein the pivot surface and the recess are configured so as to allow the removable finishing element to pivot relative to the pivot surface.

25. The tool body of claim 24 wherein the pivot surface is configured so as to define a pivot axis such that the pivot axis is below a plane containing the finishing surface.

26. The tool body of claim 25 wherein the tool body has a first direction of motion when in use, and pivot axis is transverse to the first direction of motion.

27. The tool body of any of the preceding claims 10-26 further including a resilient compressible element for helping to releasably secure a removable finishing element in the tool body.

28. The tool body of claim 27 wherein the resilient compressible element is biased in a direction of a trailing edge of tool body when a removable finishing element is secured in the tool body.

29. The tool body of any of the preceding claims 27-28 wherein the resilient compressible element includes a spring.

30. The tool body of any of the preceding claims 27-29 wherein the resilient compressible element includes a foam material.

31. The tool body of any of the preceding claims 10-30 further including a gasket element positioned in the recess.

32. The tool body of any of the preceding claims 10-31 further including a control mounting structure on a side of the tool body opposite the finishing surface.

33. The tool body of claim 32 wherein the control mounting structure extends longitudinally of the tool body.

34. The tool body of any of the preceding claims 32-33 wherein the control mounting structure includes a dovetail configuration.

35. A manual concrete finishing tool body for receiving a removable concrete finishing element, the tool body comprising a finishing surface facing in a first direction, corresponding to a worksurface to be finished by the tool, a perimeter of the finishing surface defined by sidewalls of the tool body, at least a first recess formed in the finishing surface so that the recess extends away from the finishing surface in a second direction substantially opposite the first direction, and at least a first protrusion positioned in the recess such that at least a portion of the protrusion is in the recess below the finishing surface.

36. The tool body of claim 35 further including a second protrusion positioned in a second recess such that at least a portion of the second protrusion is in the second recess below the finishing surface.

37. The tool body of claim 36 wherein the first and second recesses are coextensive.

38. The tool body of any of claims 35-37 wherein the first protrusion is compressible.

39. The tool body of any of the preceding claims 35-38 wherein the first protrusion is positioned in the recess with a portion of the first protrusion spaced from the finishing surface a first distance configured to allow pivoting of the removable finishing element relative to the tool body.

40. The tool body of claim 39 wherein the first protrusion includes a curved surface.

41. The tool body of claim 40 wherein the curved surface on the first protrusion is a partially cylindrical surface.

42. The tool body of any of the preceding claims 35-41 wherein the first protrusion is configured to define a pivot axis wherein the pivot axis extends below the finishing surface on a side of the finishing surface opposite a worksurface be finished by the tool body.

43. The tool body of claim 42 having a direction of motion when the tool body is used for finishing a concrete surface and wherein the pivot axis extends transverse to the direction of motion.

44. The tool body of any of the preceding claims 42-43 wherein the pivot axis does not intersect a plane of the finishing surface.

45. A manual concrete finishing tool body for receiving a removable concrete finishing element, the tool body comprising a finishing surface and a resiliently compressible element adjacent the finishing surface for engaging the removable concrete finishing element.

46. The tool body of claim 45 wherein the resiliently compressible element is axially compressible.

47. The tool body of any of the preceding claims 45-46 wherein the resiliently compressible element includes a spring.

48. The tool body of any of the preceding claims 45-47 wherein the resiliently compressible element includes a plunger having a concave surface.

49. The tool body of claim 45 wherein the resiliently compressible element includes a planar element compressible into a plane of the planar element.

50. The tool body of claim 49 wherein the planar element is formed from a foam material.

51. A manual concrete finishing tool body for receiving a removable concrete finishing element, the tool body comprising a finishing surface and a gasket adjacent the finishing surface and configured to be contacted by a portion of the removable concrete finishing element when the removable concrete finishing element is supported by tool body.

52. The tool body of claim 51 wherein the gasket is compressible.

53. The tool body of any of the preceding claims 51-52 wherein the gasket is formed from a foam material.

54. A manual concrete finishing tool body for receiving a removable concrete finishing element, the tool body comprising a planar body portion having a finishing surface facing in a first direction for contacting a worksurface and a manual control mounting structure wherein the attachment structure extends in a second direction away from the first direction so that the attachment structure is raised and wherein the raised attachment structure includes a recess or cavity having at least one securement element for securing a removable finishing element.

55. The tool body of claim 54 wherein the raised attachment structure includes a portion having a dovetail configuration.

56. The tool body of claim 55 wherein the at least one securement element is positioned in at least a portion of the raised attachment structure having the dovetail configuration.

57. A removable concrete finishing element comprising a base and a finishing element having a finishing surface, wherein the base includes side walls defining a perimeter and a base portion within the perimeter facing in a direction away from the finishing surface and wherein the base portion includes at least one projection extending from the base portion away from the finishing surface.

58. The finishing element of claim 57 wherein the projection includes at least one of a latch, clip, hook, magnet and angled wall, wherein the side walls defining a perimeter define a plane and wherein the angled wall extends at an angle relative to the plane.

59. The finishing element of any of the preceding claims 57-58 wherein the at least one projection extends away from the plane defined by the perimeter defined by the sidewalls and outward from the plane in a direction away from the finishing surface.

60. The finishing element of any of the preceding claims 57-59 wherein the at least one projection is configured to define a pivot axis for the at least one projection such that the removable concrete finishing element pivots about the pivot axis when the finishing element engages a tool body.

61. An assembly of a tool body of any of the preceding claims 1-56 and a finishing element of any of the preceding claims 57-60 wherein the tool body and the finishing element are secured together.

62. The assembly of claim 61 wherein the tool body and the finishing element are secured together through at least one inter-engagement and wherein the at least one inter-engagement is not exposed to concrete during use of the assembly.

63. The assembly of claim 61 wherein the at least one inter-engagement is positioned in a concave area in the tool body.

64. The assembly of any of the preceding claims 62-63 wherein the at least one inter-engagement does not extend beyond a perimeter of the finishing surface.

65. The assembly of any of the preceding claims 61-64 wherein the finishing element includes perimeter sidewalls on a base of the finishing element and the tool body includes a plurality of walls adjacent the perimeter sidewalls on the base of the finishing element, and wherein the perimeter sidewalls on the base and the plurality of walls on the tool body extend at respective non-right angles to a plane defined by the finishing surface.

66. A method of assembling a manual concrete tool body according to any of the preceding claims 1-56 and a removable concrete finishing element according to any of the preceding claims 57-60 comprising engaging the at least one projection on the finishing element with the engagement on the tool body.

67. The method of claim 66 further including pivoting the finishing element relative to the tool body.

68. The method of any of the preceding claims 66-67 further including compressing a compressible element of the tool body.

69. The method of claim 68 wherein compressing includes compressing a spring.

70. The method of claim 68 wherein compressing includes compressing a foam material.

71. The method of any of the preceding claims 68-69 wherein compressing the compressible element includes moving the finishing element so that a second projection on the finishing element engages a second engagement on the tool body.

72. The method of claim 71 wherein engagement of the second projection on the finishing element with the second engagement on the tool body engages to angled surfaces with each other.

73. The method of any of the preceding claims 66-72 wherein engaging the at least one projection on the finishing element with the engagement on the tool body covers the engagement on the tool body from view.

74. A kit or assembly of a plurality of concrete finishing elements wherein at least two concrete finishing elements in the plurality of concrete finishing elements have bases wherein each base on each of the at least two concrete finishing elements have projections extending outward of an interior of the base and are sufficiently similar to be separately mountable on to a single manual concrete finishing tool body.

75. The kit or assembly of claim 74 wherein each base is substantially identical to each other.

76. The kit or assembly of any of the preceding claims 74-75 wherein the at least two concrete finishing elements have different shapes.

77. The kit or assembly of any of the preceding claims 74-76 further including a manual concrete finishing tool body.

78. The kit or assembly of any of the preceding claims 74-77 wherein the at least two concrete finishing elements are first and second concrete finishing elements, wherein the first and second concrete finishing elements include first and second protrusions respectively extending from their respective bases, and wherein the first and second protrusions have respective geometries that are substantially identical.

79. The kit or assembly of any of the preceding claims 74-77 wherein the at least two concrete finishing elements are first and second concrete finishing elements, each of which have respective protrusions having distal-most surfaces, and wherein the first and second concrete finishing elements have respective first and second bases defining a perimeter including a proximal-most surface, and wherein a distance between the distal-most surface and the proximal-most surface on the first concrete finishing element is substantially identical to that on the second concrete finishing element.

80. The kit or assembly of any of the preceding claims 74-77 wherein the at least two concrete finishing elements are first and second concrete finishing elements, each of which have respective first and second protrusions extending from the respective base away from respective finishing surfaces, and wherein a spacing between the first and second protrusions on the first concrete finishing element is substantially the same as a spacing between the first and second is on the second concrete finishing element.

81. The kit or assembly of any of the preceding claims 74-77 wherein the at least two concrete finishing elements are first and second concrete finishing elements, each of which have respective first and second protrusions extending from the respective base away from respective finishing surfaces, and wherein a spacing between the first protrusion and a sidewall on a perimeter of the base on the first concrete finishing element is substantially the same as a spacing between the second protrusion and a sidewall on a perimeter of the base on the second concrete finishing element.

82. A kit or assembly of a plurality of concrete finishing elements according to any of the preceding claims 57-60.

83. The kit or assembly of claim 82 further including a manual concrete finishing tool body according to any of the preceding claims 1-56.

84. A manual concrete finishing tool comprising a handle, a tool body with a support for the handle on a first surface and having a concrete finishing surface facing in a direction opposite the first surface, and a removable finishing element configured to be positioned in the concrete finishing surface, wherein at least one of the handle and the finishing element are removable.

85. The tool of claim 84 wherein the tool body includes a channel in the concrete finishing surface for supporting the finishing element.

86. The tool of claim 85 wherein the concrete finishing surface is substantially planar and the finishing element includes a base having at least one wall extending flush with the substantially planar concrete finishing surface.

87. The tool of any of the preceding claims 84-86 wherein the tool body includes a latch for releasably securing the finishing element.

88. The tool of claim 87 wherein the latch includes a biasing element for biasing the finishing element in the tool.

89. The tool of any of the preceding claims 87-88 wherein the latch includes a guide for positioning the latch in the tool body.

90. The tool of any of the preceding claims 87-89 wherein the latch includes a seat for receiving a portion of the finishing element.

91. The tool of any of the preceding claims 84-88 wherein the tool body includes an angled wall for receiving a portion of the finishing element.

92. The tool of claim 91 wherein the angled wall engages an angled wall on the finishing element.

93. The tool of claim 91 wherein the angled wall engages a surface on a base of the finishing element when the finishing element is being inserted in the tool.

94. The tool of any of the preceding claims 84-93 wherein the finishing element includes a base having first and second securement elements extending outward from the base in a first direction and the finishing element includes a finishing wall extending in a second direction opposite the first direction.

95. The tool of claim 94 wherein the first and second securement elements extend in directions nonparallel to each other.

96. The tool of any of the preceding claims 94-95 wherein the first securement element includes an angled wall for engaging an angled wall in the tool body and the second securement element includes a curved wall for engaging a curved wall in the tool body.

97. The tool of any of the preceding claims 84-96 wherein the finishing element includes a base for engaging the tool body.

98. The tool of any of the preceding claims 84-97 wherein the handle includes a nut threaded onto threads of the handle and wherein the nut and the tool body are configured to place an engagement between the handle and the tool body in tension.

99. The tool of claim 98 wherein threading of the nut toward the tool body places the engagement in tension.

100. The tool of any of the preceding claims 98-99 wherein the threads on the handle are formed on a cylinder positioned between a gripping element on the handle and dovetail groove walls configured to engage a dovetail on the tool body.

101. The tool of any of the preceding claims 84-100 wherein the handle includes at least one angled surface.

102. The tool of claim 101 wherein the at least one angled surface is a first angled surface and wherein the handle includes a second angled surface.

103. A handheld concrete tool comprising a handle with a nut, a tool body with a support for the handle on a first surface and having a concrete finishing surface facing in a direction opposite the first surface, and a finishing element configured to be positioned in the concrete finishing surface, wherein the nut on the handle threaded in a direction of the tool body places an engagement between the handle and the tool body in tension.

104. The tool of claim 103 wherein the handle includes a threaded cylinder and first and second dovetail walls having a first outside dimension and wherein the nut is greater than the first outside dimension.

105. The tool of any of the preceding claims 103-104 wherein the nut includes a plurality of depressions for gripping the nut.

106. The tool of any of the preceding claims 103-105 wherein the nut is configured to bear against an upper surface of a dovetail on the tool body.

107. A manual concrete finishing tool body configured to receive a removable concrete finishing element, the body comprising a concrete finishing body portion and a manual control mounting portion wherein the finishing body portion and the manual control mounting portion define body surface portions defining a body envelope, at least one engagement structure configured for engaging a component on a removable concrete finishing element wherein the at least one engagement structure has at least a portion of the structure interior to the body envelope.

108. The tool body of claim 107 wherein the finishing body portion defines a side of the body profile in side view and the side of the body profile is substantially straight.

109. The tool body of claim 108 wherein the side of the body profile is defined by a side of the concrete finishing body portion.

110. The tool body of any of the preceding claims 107-109 wherein the at least one engagement structure is positioned in a groove in the concrete finishing body portion.

111. The tool body of claim 110 wherein the groove is formed in a finishing surface of the concrete finishing body portion and the at least one engagement structure is recessed below the finishing surface.

112. The tool body of any of the preceding claims 107-111 wherein substantially all of the at least one engagement structure is positioned within the interior of the body envelope.

113. The tool body of any of the preceding claims 111-112 further including a compressible element interior to the body envelope.

114. The tool body of claim 113 wherein the compressible element includes a spring.

115. The tool body of claim 113 wherein the compressible element is a plastic material.

116. A manual concrete finishing tool comprising a tool body with a finishing surface facing a first direction and an opposite surface facing in a second direction away from the finishing surface opposite the first direction and a handle mounted on the opposite surface, wherein the handle includes a first portion adjacent a mounting to the opposite surface and a second portion opposite the first portion and a third portion connecting the first and second portions, wherein the third portion extends at an angle to the second direction.

117. The tool of claim 116 wherein the handle includes a fourth portion connecting the first and second portions and wherein the fourth portion extends at an angle to the second direction.

118. The tool of any of the preceding claims 116-117 wherein the handle has a hollow substantially trapezoidal geometry.

119. The tool of claim 116 wherein the handle is a cantilever handle.

120. The tool of any of the preceding claims 116-119 wherein the handle has a width and a height from the mounting and wherein the width is approximately one half the height.

121. The tool of any of the preceding claims 116-120 wherein the handle is removable.

122. A removable manual control structure for a manual concrete finishing tool, wherein the manual control structure comprises a bearing surface facing away from the manual control structure for engaging a surface on the manual concrete finishing tool, wherein the bearing surface is formed from a first material and includes an insert formed from a second material wherein the second material has a higher coefficient of friction than the first material.

123. The control structure of claim 122 wherein the bearing surface is on a nut, and the insert is a ring set into a groove on the nut.

124. The control structure of any of the preceding claims 122-123 wherein the control structure includes one of a handle and a pole mount.

125. The control structure of any of the preceding claims 122-124 further including a releasable control structure configured to allow the manual control structure to be fixed at one of a plurality of angular configurations relative to a point on the bearing surface.

126. A manual concrete finishing tool having a finishing surface facing in a first direction for a worksurface away from the tool, wherein the finishing surface extends at least partly in a finishing surface plane, a releasable control structure on a portion of the tool opposite the finishing surface wherein the releasable control structure is configured to be positioned in selected angular positions in a second plane substantially parallel to the finishing surface plane.

127. The tool of claim 126 wherein the releasable control structure is configured to be positionable in 10° increments or less.

128. The tool of claim 127 wherein the releasable control structure is configured to be positionable in 5° increments.

129. The tool of any one of the preceding claims 126-128 wherein the releasable control structure includes a turret housing a gear.

130. The tool of any of the preceding claims 126-129 wherein the releasable control structure includes one of a pole attachment and a handle.

131. A releasably lockable pivot interface for a manual tool, the interface comprising a housing having a first housing body and a second housing body joined together, wherein the first housing body includes a first surface for receiving a control mechanism pivotally fixed relative to the first surface and wherein the second housing body includes a second surface for a tool body to be received on the second surface pivotally fixed relative to the second surface and a non-circular indexing element releasably supported in one of the first and second housing bodies and pivotally fixed in the other of the first and second housing bodies, wherein the indexing element can be releasably fixed in the one of the first and second housing bodies to change and angular orientation of the other of the first and second housing bodies relative to the one of the first and second housing bodies.

132. The interface of claim 131 wherein the indexing element includes a plurality of tabs distributed about the indexing element.

133. The interface of any of the preceding claims 131-132 wherein the indexing element includes a plurality of teeth distributed about the indexing element.

134. The interface of claim 133 further including a releasable engagement element engaging at least one of the teeth.

135. The interface of any of the preceding claims 131-134 wherein the first housing body includes at least one securement element for securing a manual control element to the first housing body.

136. The interface of any of the preceding claims 131-135 wherein the second housing body includes at least one securement element for securing a tool body to the second housing body.

137. The interface of claim 136 wherein the at least one securement element on the second housing body includes a dovetail configuration.
